(19) United States
(12) Patent Application Publication
(10) Pub. No.: US 2021/0259915 A1
(43) Pub. Date: Aug. 26, 2021

(54) Systems and Methods for HighSpeed Vibration Therapy

(71) Applicant: Rapid Release Technology, LLC, Costa Mesa, CA (US)

(72) Inventors: Stanley Robert Stanbridge, Costa Mesa, CA (US); David Jeffrey Maier, Irvine, CA (US)

(21) Appl. No.: 17/193,336

(22) Filed: Mar. 5, 2021

Related U.S. Application Data
(63) Continuation-in-part of application No. 16/723,135, filed on Dec. 20, 2019.
Application No. 16/723,135 is a continuation of application No. 15/009,177, filed on Jan. 28, 2016, now Pat. No. 10,548,810.
(60) Provisional application No. 62/276,386, filed on Jan. 8, 2016.
(60) Provisional application No. 62/108,712, filed on Jan. 28, 2015.

(51) Int. Cl. A61H 23/02; A61H 23/00; A61H 7/00

(52) U.S. Cl. CPC A61H 23/0263; A61H 23/006; A61H 7/003; A61H 7/005; A61H 7/001; A61H 2201/169; A61H 2201/0157; A61H 2201/0153; A61H 2201/1215; A61H 2201/0271; A61H 2201/5005

(57) ABSTRACT

A massager providing massaging frequencies in the range of 75 to 250 hertz, and preferably 100 to 200 Hertz is provided. The massager includes a motor for generating rotational motion, an applicator head having multiple treatment surfaces, and a shaft attached to the motor and applicator head for translating the rotational motion to the applicator head. The massager also includes a restraining mechanism attached to the applicator head. The restraining mechanism is configured to prevent the applicator head from rotating, thereby generating a circular motion in each of the treatment surface. The circular motion has diameters in a range of 0.1 mm to 5 mm and a preferred frequency of 100-200 completed circular movements per second.

### CROSS-REFERENCE

The present application is a continuation-in-part application of U.S. patent application Ser. No. 16/723,135, titled “Systems and Methods for High Speed Vibration Therapy”, and filed on Dec. 20, 2019, which is a continuation of U.S. patent application Ser. No. 15/009,177, titled “Systems and Methods for High Speed Vibration Therapy”, filed on Jan. 28, 2016, and issued on Feb. 4, 2020 as U.S. Pat. No. 10,548,810, which, in turn, relies on U.S. Patent Provisional Application No. 62/108,712, of the same title, and filed on Jan. 28, 2015, for priority. In addition, the '135 application relies on U.S. Patent Provisional Application No. 62/276,386, of the same title, and filed on Jan. 8, 2016, for priority. The above applications are herein incorporated by reference in their entirety.

### FIELD

The present specification relates generally to devices and methods for massage therapy. More particularly, the present specification relates to a massage head and a method of delivering a high frequency massaging vibration, for therapy and pain relief, to a portion of the body without generating excess heat.

### BACKGROUND

Scar tissue forms in the body as a temporary patching mechanism for wounds caused by surgery, trauma or repetitive stress. Scar tissue fastened to tissues that are not otherwise connected are called adhesions. Adhesions can spread, entrapping nerves, causing pain or numbness and limiting range of motion. Un-diagnosed pain and restricted mobility are likely to be caused by these scar tissue adhesions. Several soft tissue problems may be caused by adhesions. Some of such problems include: carpal tunnel syndrome, tendinosis, muscle spasms, trapped nerves, restricted range of motion, contractures, neuromas, back, shoulder and ankle pain, headaches, knee problems, and tennis elbow.

Known therapies for relieving pain caused by scar tissue adhesions include directing vibrations towards the affected areas. Massaging an affected body part with vibrations such as sound vibrations caused by various types of instruments have been known to provide some pain relief. However, sound vibrations are not as effective as mechanical vibrations for treating pain caused by scar tissue adhesions. This is because while reflection of sound waves occurs at the air-skin interface, mechanical vibrations efficiently transfer compression waves through the skin barrier.

Conventional massagers direct mechanical vibrations of a plurality of frequencies to an affected body part for providing pain relief, but they fail to operate at frequencies needed to vibrate scar tissue adhesion with a resonating frequency.

There is a need for a device that can deliver effective pain relief by operating at a massaging frequency that causes scar tissue adhesions to vibrate with a resonating frequency. There is a need for a device that can operate at specific mechanical vibration frequencies that resonate with different types of body tissues. There is also a need for a device that can operate at particular frequencies known to resonate directly with fibrotic yellow scar tissue without harmful effects to the surrounding tissues. In sum, there is a need for a therapy that uses mechanical vibrations of specific frequencies to reach and treat scar tissue adhesions that are the cause of pain.

### SUMMARY

The following embodiments and aspects thereof are described and illustrated in conjunction with systems, tools and methods, which are meant to be exemplary and illustrative, not limiting in scope. The present specification discloses numerous embodiments.

The present specification discloses a massager comprising: a motor assembly comprising a motor positioned inside a housing, wherein the motor is configured to generate a rotational motion; an applicator head comprising a plurality of treatment surfaces, wherein a portion of the applicator head is mechanically coupled to the motor; a restraining mechanism mechanically coupled to said applicator head, wherein the restraining mechanism is configured to prevent the applicator head from rotating in response to the rotational motion, thereby generating vibrational motion in said applicator head, wherein the restraining mechanism comprises an elastic member attached to a surface of the motor assembly to form a first set of connection points and attached to a portion of the applicator head to form a second set of connection points and wherein the first set of connection points is positioned proximal along a longitudinal axis of the massager relative to the second set of connection points.

Optionally, a position of each of the first set of connection points around a periphery of the elastic member alternates with a position of each of the second set of connection points around the periphery of the elastic member.

Optionally, a position of a first of the first set of connection points around a periphery of the elastic member is proximal along the longitudinal axis relative to a position of a first of the second set of connection points around said periphery, wherein a position of a second of the first set of connection points around said periphery is proximal along the longitudinal axis relative to a position of a second of the second set of connection points around said periphery, and wherein a position of a third of the first set of connection points around said periphery is proximal along the longitudinal axis relative to a position of a third of the second set of connection points around said periphery. Optionally, the periphery of the elastic member has a circumferential shape wherein each of the first set of connection points around the circumferential periphery of the elastic member alternates with a position of each of the second set of connection points around said circumferential periphery.

Optionally, the applicator head further comprises a head comprising the plurality of treatment surfaces on an exterior surface of the head and a component configured to be received in a cavity of the first head. Optionally, the applicator head is mechanically coupled to the restraining mechanism by attaching the elastic member to the component. Optionally, the component is in the form of a ring having a plurality of members extending therefrom. Optionally, the elastic member is attached to the component at some of the plurality of members thereby forming the second set of connection points. Optionally, the component is mechanically coupled to the head by inserting some of the plurality of members into receiving structures within the cavity of the head.

Optionally, the applicator head further comprises a head comprising the plurality of treatment surfaces on an exterior surface of the head and a cylindrical component configured to be received in a cavity of the first head, wherein the cylindrical components comprises a first set of radially protruding members and a second set of radially protruding members. Optionally, the elastic member is attached to each of the first set of radially protruding members to form the second set of connection points. Optionally, each of the second set of radially protruding members of the cylindrical component is mechanically coupled to receiving structures within the cavity of the head.

Optionally, at least one of the plurality of treatment surfaces projects radially outwards from the applicator head.

Optionally, the plurality of treatment surfaces includes a first treatment surface, a second treatment surface, and a third treatment surface and wherein the first treatment surface has a coefficient of friction that is different than the second treatment surface or third treatment surface.

Optionally, the plurality of treatment surfaces includes a first treatment surface, a second treatment surface, and a third treatment surface and wherein the first treatment surface comprises a material that is more compliant than a material covering the second treatment surface or a material covering the third treatment surface.

Optionally, at least one of the plurality of treatment surfaces comprises silicone.

Optionally, a three of the plurality of treatment surfaces project radially outwards from the applicator head and are positioned equidistant from each other on a periphery of the applicator head. Optionally, an additional three of the plurality of treatment surfaces are positioned on the applicator head and between the three of the plurality of treatment surfaces that project radially outwards from the applicator head.

Optionally, a frequency of the vibrational motion ranges from 75 Hz to 250 Hz and causes each of the plurality of treatment surfaces move in an approximately circular motion with a speed ranging from 100 to 200 circles per second.

Optionally, the massager further comprises a rotating shaft mechanically coupled to the motor and an eccentric shaft mechanically coupled to the head for translating a rotational motion of the head into a substantially circular motion.

Optionally, the housing is coupled with a counterweight for balancing centrifugal force caused by the substantially circular motion of the head.

In some embodiments, the present specification discloses a massager comprising: a motor for generating rotational motion; an applicator head comprising a plurality of treatment surfaces; a shaft attached to said motor and said applicator head for translating said rotational motion to the applicator head; a restraining mechanism attached to said applicator head, wherein the restraining mechanism is configured to prevent the applicator head from rotating, thereby generating vibrational motion in said applicator head and a substantially orbital motion in said plurality of treatment surfaces.

Optionally, at least one of the plurality of treatment surfaces projects radially outwards from the applicator head. Optionally, the plurality of treatment surfaces includes a first treatment surface, a second treatment surface, and a third treatment surface and wherein the first treatment surface has a coefficient of friction that is different than the second treatment surface or third treatment surface. Still optionally, the plurality of treatment surfaces includes a first treatment surface, a second treatment surface, and a third treatment surface and wherein the first treatment surface comprises a material that is more compliant than a material covering the second treatment surface or a material covering the third treatment surface. Still optionally, at least one of the plurality of treatment surfaces comprises silicone. Optionally, three of the plurality of treatment surfaces project radially outwards from the applicator head and are positioned equidistant from each other on a periphery of the applicator head.

In some embodiments, a frequency of the vibrational motion may range from 75 Hz to 250 Hz.

In some embodiments, the orbital motion may cause said plurality of treatment surface to move in an approximately circular motion with diameters ranging from 0.1 mm to 5 mm.

In some embodiments, the plurality of treatment surfaces move in an approximately circular motion with a speed ranging from 100 to 200 circles per second.

Optionally, the restraining mechanism comprises a plurality of substantially elongate pins having distal ends attached to the applicator head and proximal ends connected to sockets positioned on a portion of the massager. Optionally, the proximal end of each pin is placed in a socket having a pre-defined volume and wherein the proximal end of each pin floats freely within the socket. Optionally, the proximal end of each pin is barrel-shaped and wherein the socket is substantially cylindrical.

Optionally, the shaft is coupled with a counterweight for balancing centrifugal force caused by eccentric motion of the applicator head.

Optionally, the massager further comprises a bearing mount assembly comprising at least one ball bearing mounted on at least one shaft for operating the applicator head, the shaft being coupled with the shaft attached to said motor and applicator head.

Optionally, the massager further comprises a bearing mount assembly comprising multiple ball bearings mounted on at least one shaft for operating the applicator head, the shaft being coupled with the shaft attached to said motor and applicator head.

In some embodiments, the massager further comprises a circuit board comprising at least a potentiometer and a switch for controlling a speed of the motor.

In some embodiments, the present specification discloses a massager comprising: a motor for generating rotational motion; an applicator head comprising a plurality of treatment surfaces; a rotating shaft attached to said motor and an eccentric shaft attached to said applicator head for translating said rotational motion to the applicator head to a substantially circular motion; a restraining mechanism attached to said applicator head, wherein the restraining mechanism is configured to prevent the applicator head from rotating, thereby generating a substantially circular motion in said plurality of treatment surfaces and wherein the substantially circular motion of said plurality of treatment surfaces has a diameter in a range of 0.1 mm to 5 mm and a frequency of 100-200 circular movements per second.

Optionally, the plurality of treatment surfaces includes a first treatment surface, a second treatment surface, and a third treatment surface, wherein the first treatment surface, second treatment surface, and third treatment surface project radially outward from the applicator head, wherein the first treatment surface is harder than the second treatment surface, and wherein the third treatment surface is rounder than the first treatment surface or second treatment surface.

Optionally, a bearing mount assembly is positioned concentrically relative to at least one of the rotating shaft or eccentric shaft and proximal to the applicator head.

Optionally, said restriction mechanism comprises a cylindrical component positioned around said bearing mount assembly and proximal to said applicator head and wherein the cylindrical component comprises a plurality of protrusions adapted to have a non-friction fit within complementary recesses located in a base of the applicator head.

Optionally, an outer circumference of the cylindrical component comprises at least one channel, wherein said at least one channel is adapted to accommodate a member connecting the applicator head to a proximal portion of the massager.

The aforementioned and other embodiments of the present specification shall be described in greater depth in the drawings and detailed description provided below.

### BRIEF DESCRIPTION OF THE DRAWINGS

These and other features and advantages of the present specification will be further appreciated, as they become better understood by reference to the detailed description when considered in connection with the accompanying drawings:

FIG. 1A illustrates a massager, in accordance with an embodiment of the present specification;

FIG. 1B is a schematic back plan view of the massager, in accordance with an embodiment of the present specification;

FIG. 1C illustrates a switch shuttle of the massager, in accordance with an embodiment of the present specification;

FIG. 2A illustrates a top view of a first side of a massager housing, in accordance with an embodiment of the present specification;

FIG. 2B illustrates a top view of a second side of massager housing, in accordance with an embodiment of the present specification;

FIG. 2C illustrates another view of the massager housing, in accordance with an embodiment of the present specification;

FIG. 2D illustrates another view of the massager housing, in accordance with an embodiment of the present specification;

FIG. 2E illustrates an internal view of the massager housing, in accordance with an embodiment of the present specification;

FIG. 2F illustrates an isometric view of the massager housing in accordance with an embodiment of the present specification;

FIG. 3 is an exploded view illustrating internal components of the massager, in accordance with an embodiment of the present specification;

FIG. 4A illustrates an isometric view of a vibrating head assembly of the massager, in accordance with an embodiment of the present specification;

FIG. 4B illustrates an isometric view of a vibrating head assembly of the massager, in accordance with an embodiment of the present specification;

FIG. 4C is an exploded, isometric view of a vibrating head assembly of the massager, as shown in FIG. 4B;

FIG. 4D is a side view illustration of a treatment surface positioned on the head of the massager, in accordance with some embodiments of the present specification;

FIG. 4E is a side view illustration of a treatment surface positioned on the head of the massager, in accordance with some embodiments of the present specification;

FIG. 4F is a side view illustration of a treatment surface positioned on the head of the massager, in accordance with some embodiments of the present specification;

FIG. 4G is a silhouette image showing exemplary dimensions of the massager, in accordance with some embodiments of the present specification;

FIG. 4H is an illustration showing two different views of a small treatment surface area that includes a rounded application area;

FIG. 4I is an illustration showing a top isometric view and bottom isometric view of a large treatment area;

FIG. 4J is an illustration showing a top perspective view of a large treatment cap 470, as used in some embodiments of the present specification;

FIG. 4K is an illustration showing a bottom perspective view of a large treatment cap, as shown in FIG. 4J;

FIG. 5A is a first perspective view of the massager, showing a cylindrical component fitted over a bearing mount, in accordance with an embodiment of the present specification;

FIG. 5B is a second perspective view of the massager of FIG. 5A;

FIG. 5C is a first perspective view of a cylindrical component of the massager in accordance with an embodiment of the present specification;

FIG. 5D is a second perspective view of the cylindrical component of FIG. 5C;

FIG. 5E is a third perspective view of the cylindrical component of FIG. 5C;

FIG. 6 illustrates a back plan view of the vibrating head assembly of the massager, in accordance with an embodiment of the present specification;

FIG. 7 illustrates an alternate embodiment of a cap having a plurality of surfaces for covering the vibrating head of the massager;

FIG. 8A is a diagram of the bearing mount assembly of the massager, in accordance with an embodiment of the present specification;

FIG. 8B is an exploded view illustrating the bearing mount assembly of the massager, shown in FIG. 8A;

FIG. 9 is an exploded view illustrating the circuit board and motor assembly portion of the massager, in accordance with an embodiment of the present specification;

FIG. 10A illustrates an exploded view of internal components of a massager using an alternative or additional restraining mechanism, in accordance with some embodiments of the present specification;

FIG. 10B is an isometric view of a motor plate, in accordance with some embodiments of the present specification;

FIG. 10C shows different views of a battery cap in accordance with some embodiments of the present specification;

FIG. 10D is an internal cross-section surface view of a first motor housing portion in accordance with some embodiments of the present specification;

FIG. 10E is an internal cross-section surface view of a second motor housing portion in accordance with some embodiments of the present specification;

FIG. 10F is a side elevation view and perspective view of the massager that shows a connection of screws alternating between the head portion through a stabilizer on one side and the handle portion through a bearing assembly of massager on the opposite side, in accordance with embodiments of the present specification;

FIG. 10G is a side elevation view and a top plan view of a distal side of the counterweight shaft, in accordance with some embodiments of the present specification;

FIG. 10H is a top plan view of a proximal side of the counterweight shaft and a cross-sectional view along a section A-A through a center of the counterweight shaft, in accordance with some embodiments of the present specification;

FIG. 10I is a cross-sectional view along a section B-B, perpendicular to section A-A, of the counterweight shaft shown in FIG. 10H, in accordance with some embodiments of the present specification;

FIG. 11A illustrates an exploded top side perspective view of a restraining mechanism, in accordance with some embodiments of the present specification;

FIG. 11B illustrates an exploded bottom side perspective view of the restraining mechanism of FIG. 11A, in accordance with some embodiments of the present specification;

FIG. 11C illustrates an exploded side view of the restraining mechanism of FIGS. 11A and 11B;

FIG. 11D illustrates a position of a bearing between a sub-orbital head and an elastic ring, in accordance with some embodiments of the present specification;

FIG. 12A illustrates a top view and a side view of a rubber ring, in accordance with some embodiments of the present specification; and

FIG. 12B illustrates a perspective view of the rubber ring of FIG. 12A, in accordance with some embodiments of the present specification.

### DETAILED DESCRIPTION

The present specification discloses a high speed vibration therapy, referred to as rapid release technology (RRT) employed in scar tissue therapy, which targets brittle scar tissues with the shearing force of planar wave energy that is readily absorbed by the brittle scar tissues but passes safely through healthy tissue. The present specification also provides an RRT massager having multiple massaging heads capable of vibrating at an optimal frequency that resonates with the scar tissue for maximum effectiveness.

Mechanical vibrations in the frequency range of 100-200 Hz directly administered to tendons or muscles cause a reflex response, termed as ‘tonic vibration reflex’ (TVR) response. This reflex response quickly relaxes the tendons or muscles causing pain relief. The RRT therapy of the present specification uses frequencies between 100-200 Hz causing a TVR response to be generated by an affected body tissue. The elicitation of the TVR in the neuromuscular system maximizes the benefits of the vibration therapy. The RRT vibration therapy enhances the excitement of corticospinal pathways to assist in the activation of cortical motor areas.

The massager of the present specification may be used to effectively provide pain relief from scar tissue adhesion conditions such as carpal tunnel syndrome, tendinosis, muscle spasms, trapped nerves, range of motion, contractures, neuromas, back, shoulder and ankle pain, headaches, knee problems, and tennis elbow. The vibration therapy of the present specification may also be used to provide relief in other tissue related pain causing conditions as well.

The present specification is directed toward multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

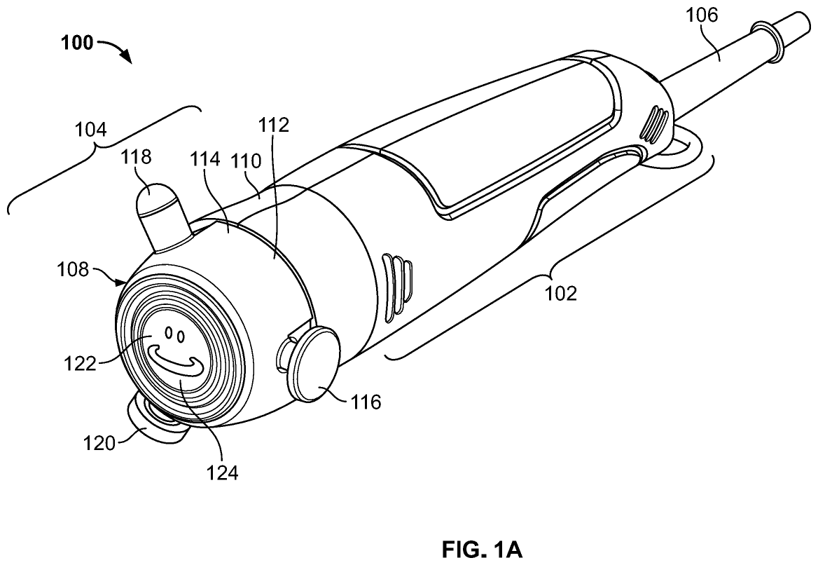

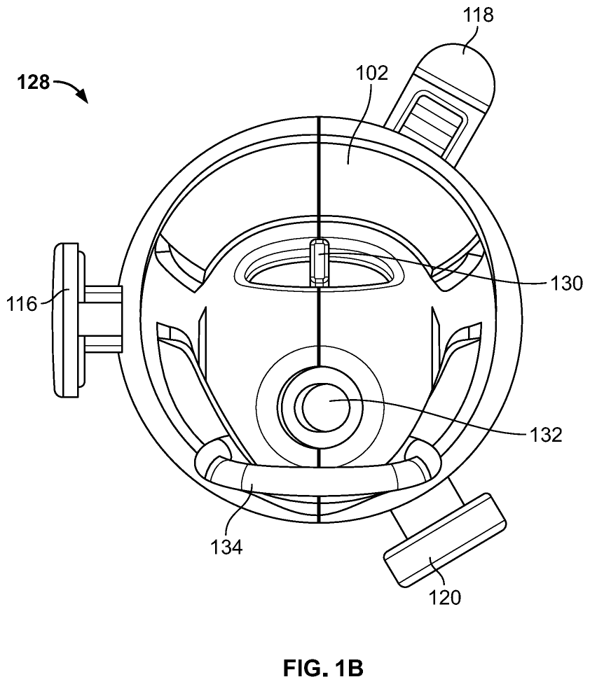

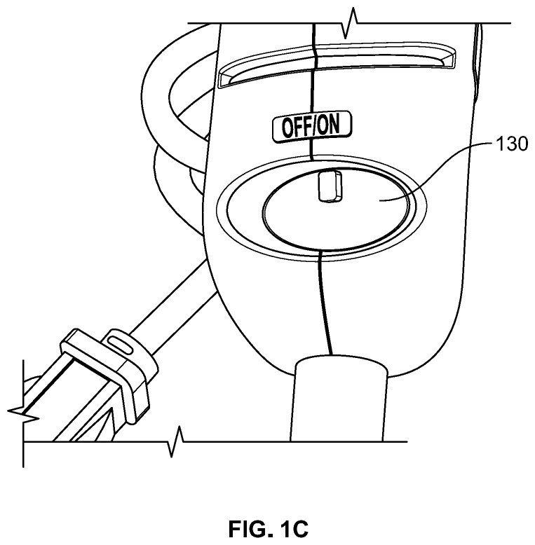

FIG. 1A illustrates a massager that employs rapid release technology, in accordance with an embodiment of the present specification. Massager 100 comprises a body portion 102, an applicator head or massager head portion 104 and a power cable 106. The applicator or massager head 104 comprises a vibrating head assembly 108 and a cover 110. The vibrating head assembly 108 and the cover 110 attach at circumferential point 112. In an embodiment, the cover 110 comprises two parts: a first cover and a second cover. The vibrating head assembly 108 comprises a vibrating head 114, a planar, flat or slightly curved treatment surface 116, a rounded treatment surface 118, a soft, flat treatment surface 120, and a front cover 122 that includes a large, contoured treatment surface 124. In some embodiments, body portion 102 further comprises a contoured handle portion that is used to hold the massager during use, affording the user a steady grip. In one embodiment, the planar treatment surface 116 is larger than the rounded treatment surface 118 or the soft planar treatment surface 120. In one embodiment, the soft planar treatment surface 120 has a lower durometer value than either the planar treatment surface 116 or rounded treatment surface 118. In one embodiment, the planar treatment surface 116 has a higher durometer rating than either the soft planar treatment surface 120 or rounded treatment surface 118. In one embodiment, the planar treatment surface 116 has a larger surface area than either the soft planar treatment surface 120 or rounded treatment surface 118. In one embodiment, the rounded treatment surface 118 is substantially cylindrical and has a smaller surface area than either the soft planar treatment surface 120 or planar treatment surface 116.

FIG. 1B illustrates a back view of the massager, in accordance with an embodiment of the present specification. A back portion 128 of the body 102 of the massager comprises a switch shuttle 130, a connection point 132 for connecting the massager with a power cable, and a curved hang ring 134. In various embodiments, the switch shuttle 130 is used to switch on the massager, enabling the treatment heads 116, 118, 120 to vibrate.

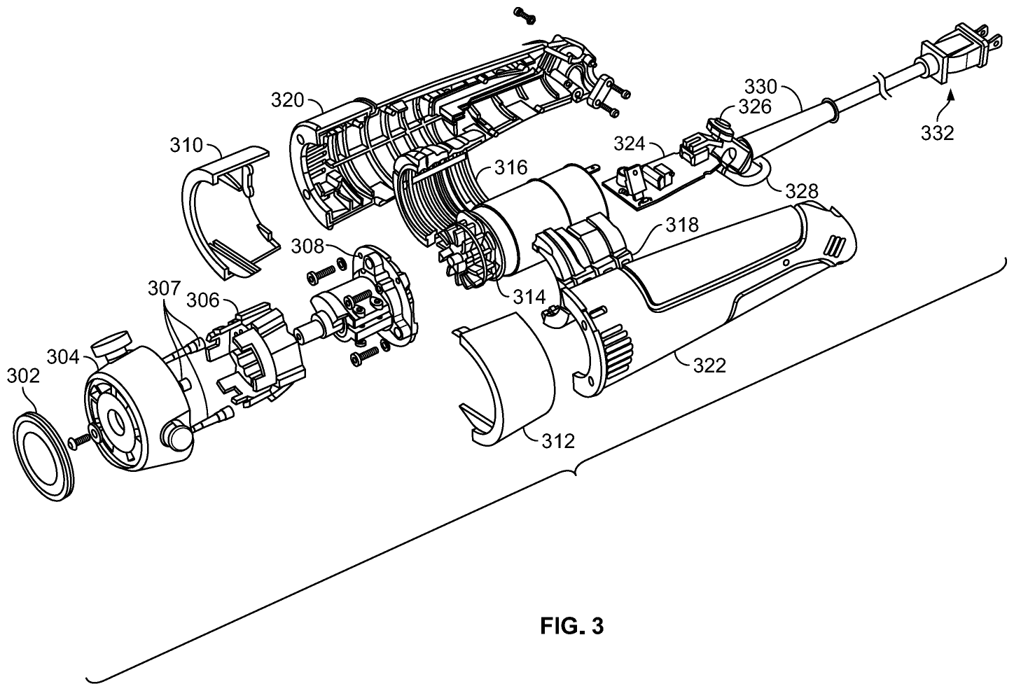

FIG. 1C illustrates the switch shuttle 130, in accordance with an embodiment of the present specification. Switch shuttle 130 is coupled with a switch provided on a circuit board of the massager (shown in FIG. 3). The switch is coupled with a potentiometer and a motor and is used to control the rotational speed of the motor, which in turn controls the vibrational speed of the one or more treatment heads. A user is enabled to power the treatment heads as well as control their vibrational speeds by operating the switch (shown in FIG. 3) via the switch shuttle 130. In an embodiment, the switch shuttle 130 allows for the user to toggle between a power on and power off state. In another embodiment, the switch shuttle may allow for the user to toggle between different power levels, such as, but not limited to low, medium and high, through which the vibration frequency can be controlled. A low power level equates to a first vibration frequency. A medium power level equates to a second vibration frequency. A high power level equates to a third vibration frequency, where the first vibration frequency is lower than the second vibration frequency which is lower than the third vibration frequency. In other embodiments, the switch shuttle may allow for the user to toggle between incremental power levels, which may be represented by a number, such as 1, 2, 3, . . . n. In an embodiment, the switch shuttle 130 can be used to power only one treatment head at a time or less than all treatment heads at a time.

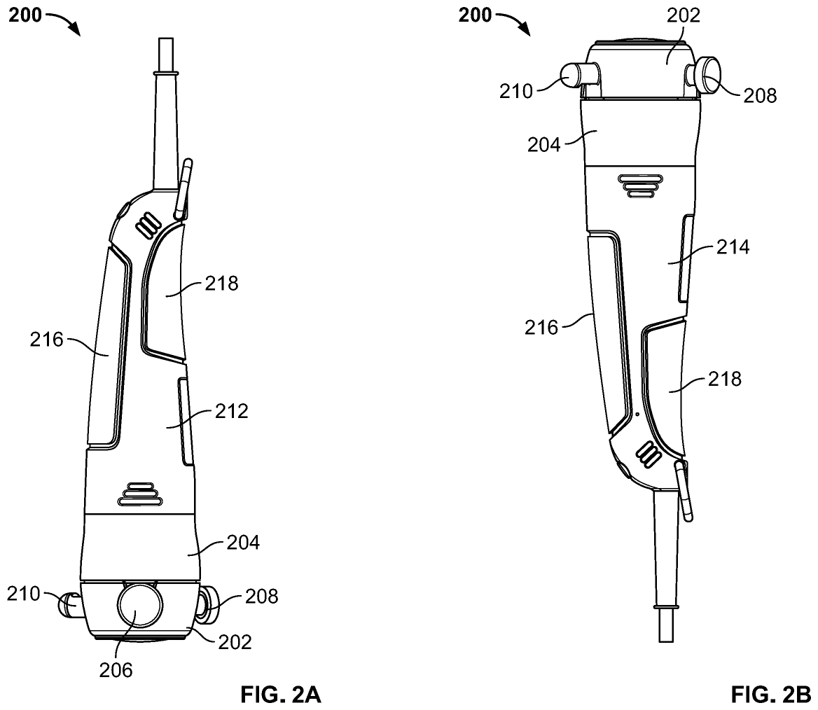

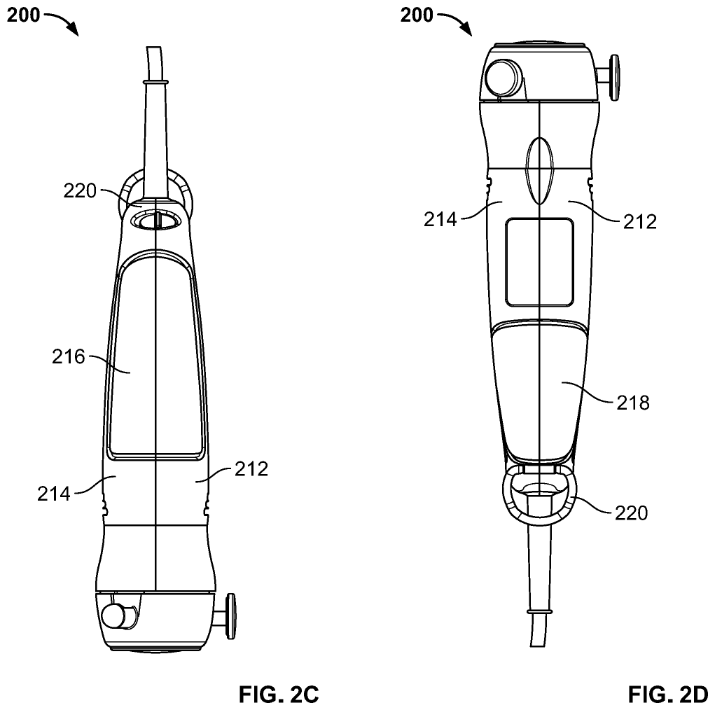

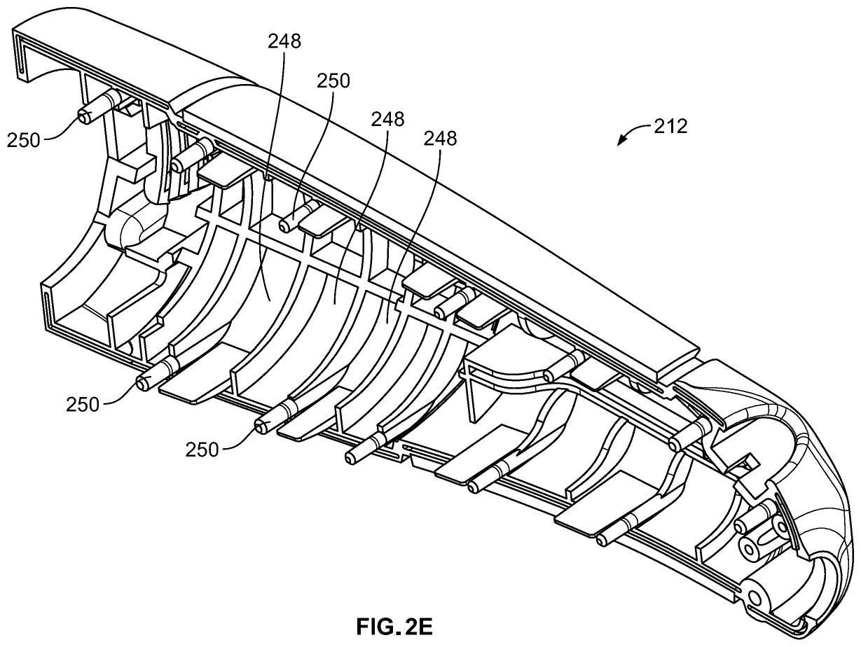

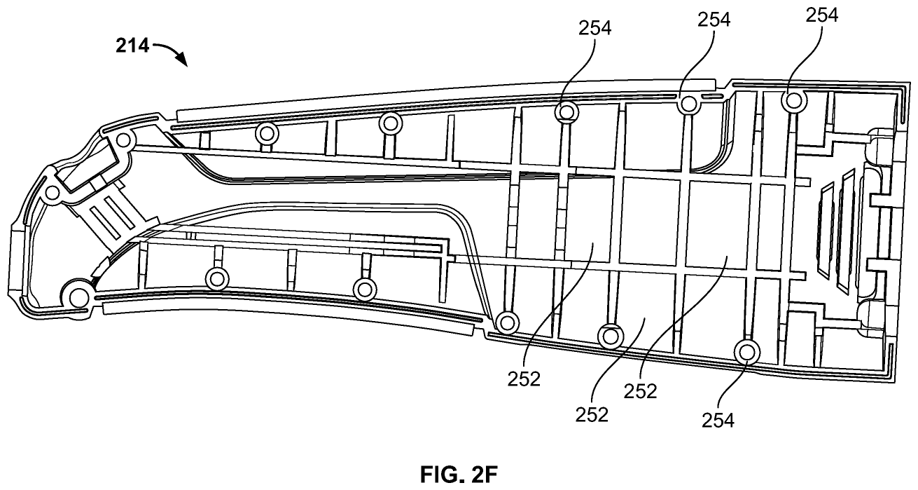

FIG. 2A illustrates a top view of a first side of the massager housing, in accordance with an embodiment of the present specification. FIG. 2B illustrates a top view of a second side of the massager housing, in accordance with an embodiment of the present specification. FIGS. 2C and 2D illustrate two more external views of the massager, in accordance with an embodiment of the present specification. Referring to FIGS. 2A and 2B, 2C and 2D, massager 200 comprises a vibrating head 202 and a housing 204 for containing a bearing mount assembly. Massager 200 further includes a first motor housing portion 212 and a second motor housing portion 214. Each of the first and second motor housing portions 212, 214 covers at least a portion of the body of the massager. In an embodiment, the first and second covers 212, 214 enclose and protect a motor (shown in FIG. 3) which enables the vibration of treatment surfaces 206, 208 and 210 to vibrate. The vibrating head 202 comprises a large treatment surface 206, a small treatment surface 208, and a soft treatment surface 210. The first and second covers 212, 214 comprise an oblong portion 216 on a top side of the massager and a smaller oblong portion 218 on an underside of the massager. Further, at least a portion of covers 212, 214 functions as a contoured handle portion, in accordance with an embodiment of the present specification, which is used to hold the massager during use and allows a user a steady grip. In some embodiments, the handle portion has a length of 9 inches. In some embodiments, the device of the present specification has an overall length of 10.5 inches. In some embodiments, the handle may also be used for hanging the massager when not in use via a hang ring 220 (shown in FIGS. 2C and 2D).

FIG. 2E illustrates an isometric view of the first cover 212 of the massager in accordance with an embodiment of the present specification. The inside of the first cover 212 comprises multiple slots 248 for holding a motor of the massager and multiple pins 250 for connecting with the second cover 214 of the massager. FIG. 2F illustrates an isometric view of the second cover 214 of the massager in accordance with an embodiment of the present specification. The inside of the second cover 214 comprises multiple slots 252 for holding a motor of the massager and multiple pins 254 for connecting with the first cover 212 of the massager.

FIG. 3 is an exploded view illustrating internal components of the massager, in accordance with an embodiment of the present specification. Massager 300 includes, but is not limited to, treatment area/disc 302, orbiting head assembly 304, rotation stabilizer or collar 306, pins 307, bearing mount assembly 308, first bearing mount assembly housing portion 310, second bearing mount assembly housing portion 312, motor assembly 314, first motor mount portion 316, second motor mount portion 318, first motor housing portion 320, second motor housing portion 322, printed circuit board 324, switch actuator 326, hang ring 328, PCB cable 330, and plug 332. Massager 300 may also include additional components such as screws and washers. The treatment area/disc 302 is detachably positioned within, or connected via a pin or member to, the orbiting head assembly 304. Pins 307 connect the orbiting head assembly 304 to the rotation stabilizer or collar 306 which, in turn, is attached to a bearing mount assembly 308 and encased within the first bearing mount assembly housing portion 310 and second bearing mount assembly housing portion 312. The bearing mount assembly 308 and hence the rotation stabilizer 306 and orbiting head assembly 304 are mechanically connected to the motor assembly 314. Motor assembly 314 is positioned within the first motor mount portion 316 and second motor mount portion 318 and the entire assembly 314, 316, 318 is positioned within the first motor housing portion 320 and second motor housing portion 322. Proximal to the motor assembly 314 and in electrical communication therewith is printed circuit board 324 and switch actuator 326. Hang ring 328, PCB cable 330, and plug 332 are proximal thereto. The functionality and components of the individual components described above are described in greater detail below with respect to the figures that follow.

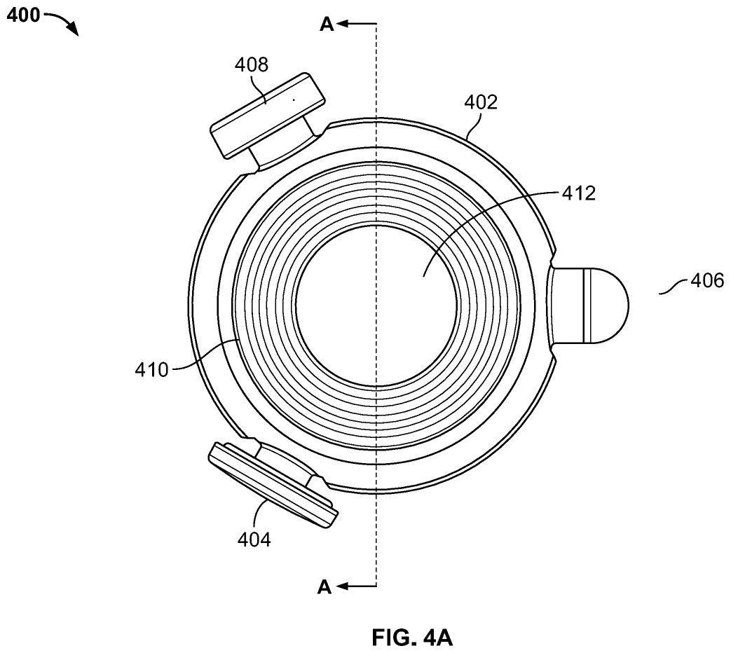

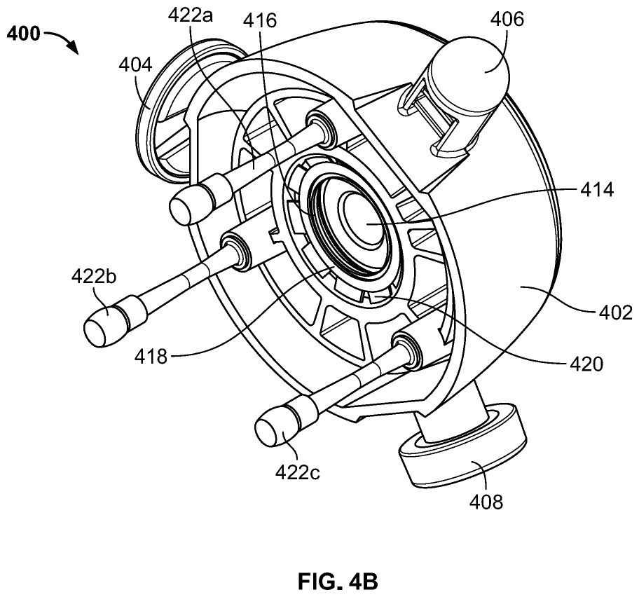

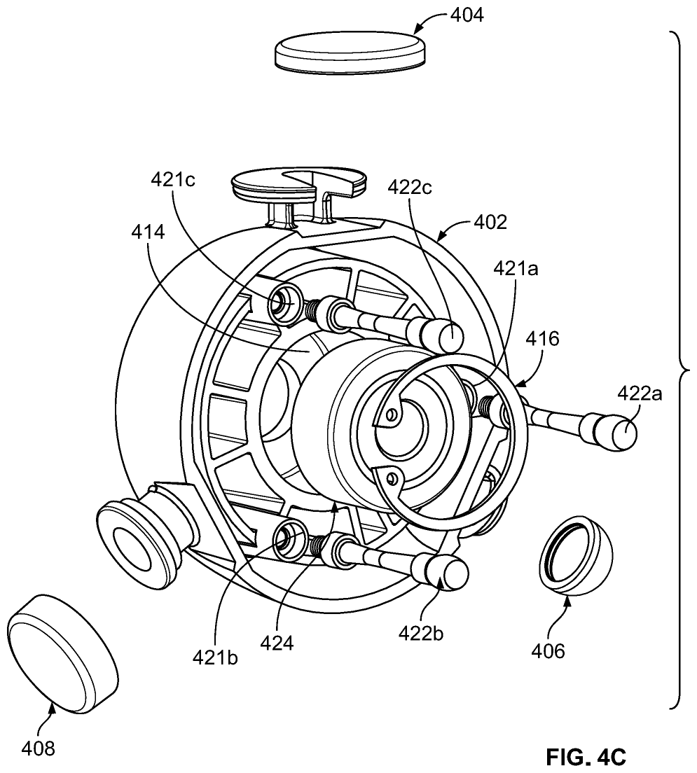

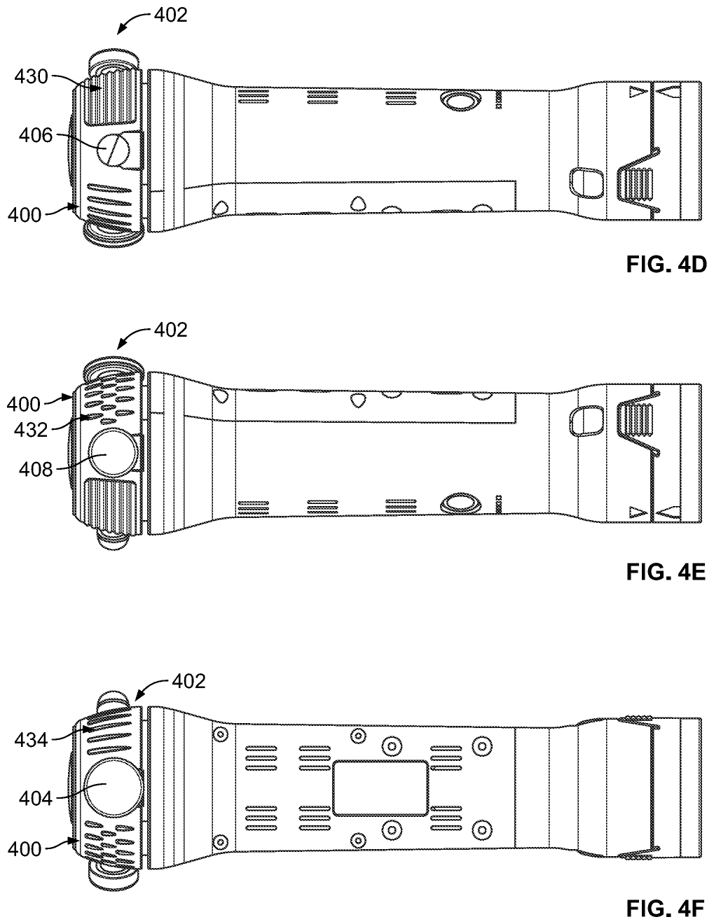

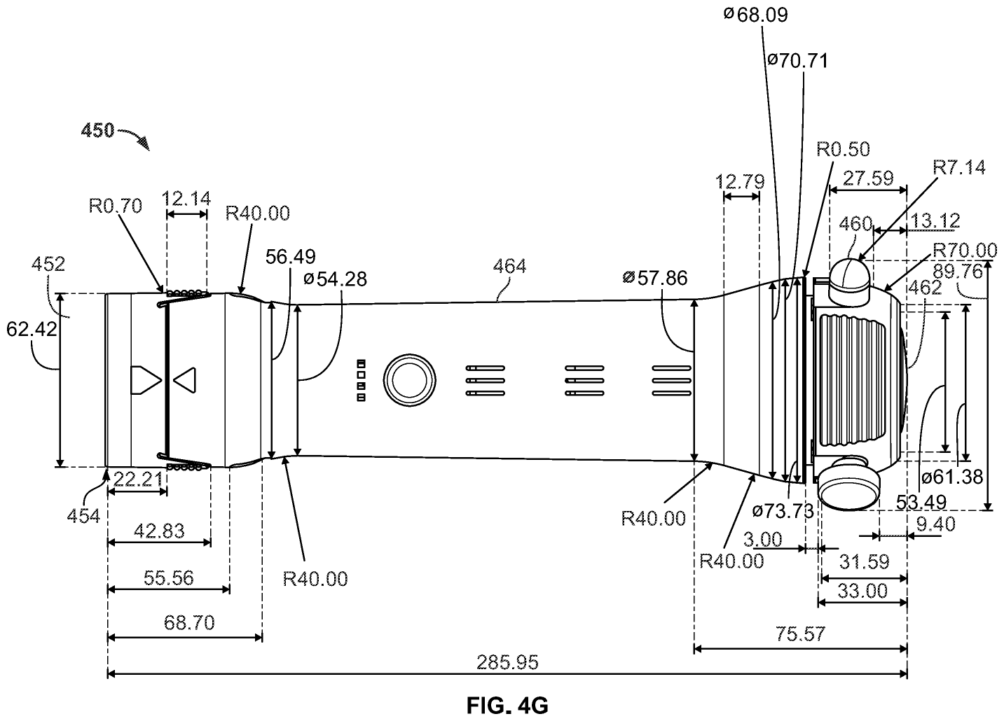

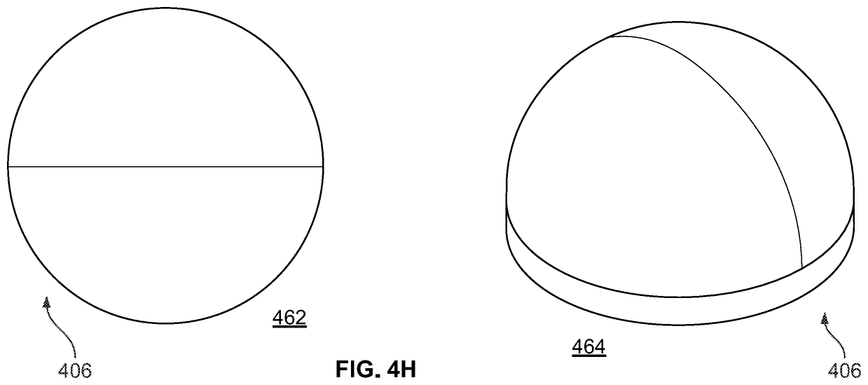

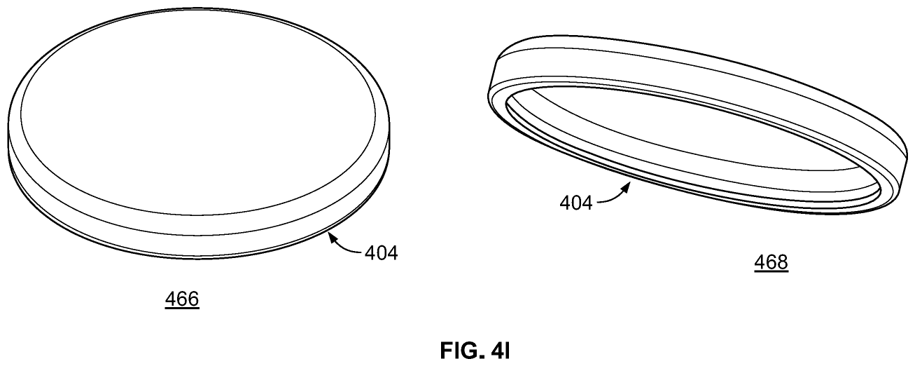

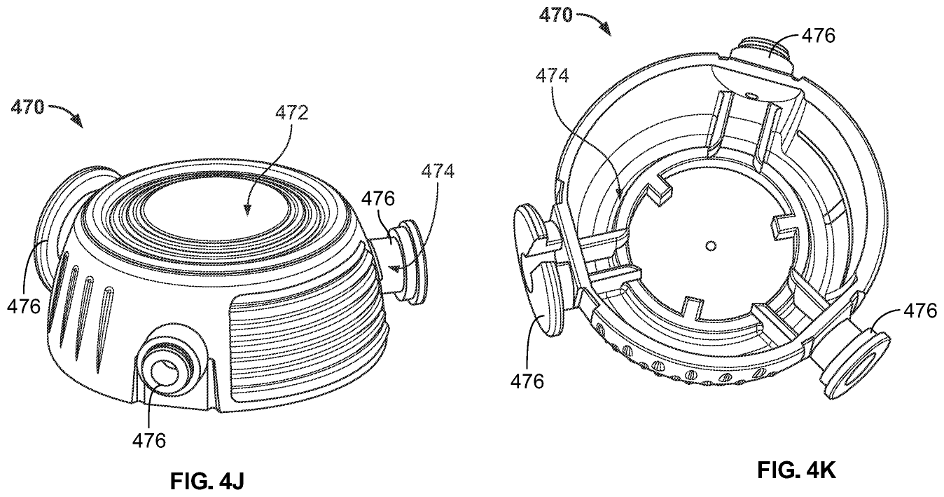

FIG. 4A illustrates a front view of the head of the massager, in accordance with an embodiment of the present specification. The head 400 comprises a vibrating or micro-orbiting portion 402 (referred to as the vibrating head assembly 108 in FIG. 1A), a large planar treatment area 404, a small rounded treatment area 406, a soft planar treatment area 408, and a front cover 410. Front cover 410 comprises a contoured treatment surface 412. Treatment areas or surfaces 404, 406 and 408 are, in an embodiment, positioned equidistantly around the periphery at a proximal end of the head 400. In an embodiment, treatment areas 404, 406, and 408 are positioned at 120 degrees from one another. Each treatment surface or area is constructed differently to provide a different type of massage therapy. The center of treatment area 412 is a smooth circle with at least one circumferential groove positioned therein. In some embodiments, small treatment area 406 comprises a rounded treatment application surface, while the large treatment area 404 and the soft treatment area 408 comprise flat treatment application surfaces. Large treatment area 404 may have a larger treatment application surface than the other treatment areas 406 and 408. In an embodiment, treatment area 404 is flat, hard and smooth. In an embodiment, treatment area 406 is round, hard, and smooth. In an embodiment, treatment area 408 is flat, soft, and smooth. In an embodiment, soft treatment area 408 comprises a silicone surface which is pliant and has a greater traction or frictional coefficient as compared to the large treatment area 404, which comprises a hard and less pliant surface, such as plastic. Further, the treatment areas 404, 406 and 408 extend radially outwards from head 400 and each of the treatment areas 404, 406, 408 has a treatment application surface that is normal to treatment area 412. The difference in design and material of the treatment areas and thus, surfaces 404, 406, 408 and 412 allows a user to apply a plurality of pressure/surfaces on an affected body part, without having to change massage heads, using only one hand, and without having to change the position of that hand. For example, the choice of material allows for the soft treatment area 408 to be used comfortably over bone dense areas.

During operation of the massager the head 402 vibrates with a pre-defined frequency, causing each of the treatment areas (and corresponding surfaces) 404, 406, 408, and 412 to move in an orbital fashion where the diameter of that motion is pre-defined. In an embodiment, the pre-defined frequency ranges from 70 to 250 Hz. In another embodiment, the pre-defined frequency ranges from 100 to 200 Hz. In some embodiments, the speed of the orbital motion of the treatment areas ranges from 100 to 200 circles per second. In another embodiment, each treatment surface 404, 406, 408 and 412 orbits with a high frequency making 130 to 200 circular motions in a second. In another embodiment, each treatment surface 404, 406, 408 and 412 orbits in a range of 150 to 175 circular motions in a second.

In an embodiment, the vibrating head 400 causes each of the treatment surfaces 404, 406, 408 and 412 to move in small orbital, or substantially circular or elliptical, increments having diameters ranging from 0.1 mm to 5 mm. In another embodiment, the diameter ranges from 0.5 mm to 3 mm. In another embodiment, the diameter of the orbit is 1.7 mm. It should be appreciated that the orbital motion may not be a perfect circle but, rather, may be a generally rounded motion that has a varying degree of diameter ranges, from 0.1 mm to 5 mm.

Since the orbital motion of the treatment surfaces are short stroke, elliptical, circular, or otherwise rounded movements, the treatment surfaces do not push away a user's skin upon application, as compared to a up and down motion or in and out motion. As the diameter of the stroke (stroke size) decreases, the frequency (or speed) may be increased in a compensatory manner to achieve the same effect, as can be tolerated by the user. The treatment areas and, thus, surfaces 404, 406, 408, and 412 may be pressed against a body part for massaging said part. Each treatment area and corresponding surface 404, 406, 408, and 412 provides a different type of massage sensation as well as relief to the body part being massaged. The high frequency motion of the treatment surfaces directly administered to tendons or muscles causes a reflex response, termed as ‘tonic vibration reflex’ (TVR) response. This reflex response quickly relaxes the tendons or muscles causing pain relief.

Also, during operation of the massager, the motion of each treatment area 402, 404, 406 and 412 is substantially identical, allowing a user to easily move from one treatment area to another without having to change modes of operation, replace heads, or even change hand positioning distinctly, for experiencing the different massage sensations provided by the different treatment surfaces.

In various embodiments, the massager of the present specification may be provided with a plurality of treatment surfaces as the same high frequency, short stroke motion of the head 400 is transferred to all the treatment surfaces concurrently. In an embodiment, the radial, arcuate surface on an outside of the vibrating portion 402 between each radial treatment area (404, 406, 408) is also used as a treatment surface and may be covered with a compliant material, or texturized differently. Further, in another embodiment, more than three radial treatment surfaces are provided and positioned around the outer periphery of the vibrating portion 402. In various embodiments, the treatment surfaces provided on the massager may be of different shapes such as but not limited to rectangular, triangular, oblong, pentagonal, hexagonal, and octagonal. Some exemplary surfaces are illustrated and described in context of FIGS. 4D, 4E, and 4F.

FIG. 4B illustrates an isometric view of the head of the massager, in accordance with an embodiment of the present specification. FIG. 4C is an exploded, isometric view of a vibrating head assembly of the massager, as shown in FIG. 4B. Referring now to FIGS. 4B and 4C, the vibrating portion 402 comprises a ball bearing contact area 414 for receiving at least one ball bearing 424, at least one retaining member 416 positioned within an internal groove, a washer 418 and a retaining clip 420 for retaining the ball bearing within the vibrating portion 402. In embodiments, retaining member 416 may be a wave spring, an internal retaining ring or any other similar mechanism for retaining the at least one bearing in place, as may be known to those of ordinary skill in the art. The vibrating portion 402 also comprises three pins 422a, 422b and 422c for connecting the vibrating portion 402 to the body of the massager. The pins 422a, 422b and 422c also restrict the free rotatory motion of the vibrating portion 402. As illustrated, pins 422a, 422b and 422c are positioned equidistantly around the circumference of head 400 (FIG. 2A). Distal ends of pins 422a, 422b and 422c are attached to an inside of vibrating portion 402.

In various embodiments, the vibrating portion 402 is made to move in an orbiting motion by means of a motor (not shown in FIG. 4B). Further, in various embodiments, during operation of the massager, the orbiting motion of the vibrating portion is restricted by using any suitable restricting means. In the embodiment illustrated in FIG. 4B, the three pins 422a, 422b and 422c extending from the vibrating portion 402 to the body of the massager restrict free rotatory movement of the vibrating portion 402, thereby generating an orbital motion of the head 400. The use of motion restricting means such as pins 422a, 422b and 422c cause the head 400 to vibrate with a high frequency and very short orbital strokes.

In the embodiment shown in FIG. 4C distal ends of pins 422a, 422b and 422c are firmly attached to the head 400 in sockets 421a, 421b and 421c respectively, while the proximal ends are free floating within sockets provided on a bearing mount assembly. Having the proximal ends free floating reduces heat generation, load, and extraneous vibrations, as compared to having the proximal end glued or fixedly attached in place. In an embodiment the distal ends of pins 422a, 422b and 422c are threaded and/or glued or affixed by any other means, to sockets 421a, 421b and 421c, respectively, located inside of the vibrating portion 402. In an embodiment, the proximal ends are positioned within substantially cylindrical sockets located on the bearing mount assembly, which allow the pins 422a, 422b and 422c to move freely, but restricted within, the space inside each socket. In embodiments, the proximal end of each of the pins has a curved, barrel-like shape. The placement of the pins within the sockets on the bearing mount assembly provides a restricting force to the rotatory movement of the vibrating portion 402.

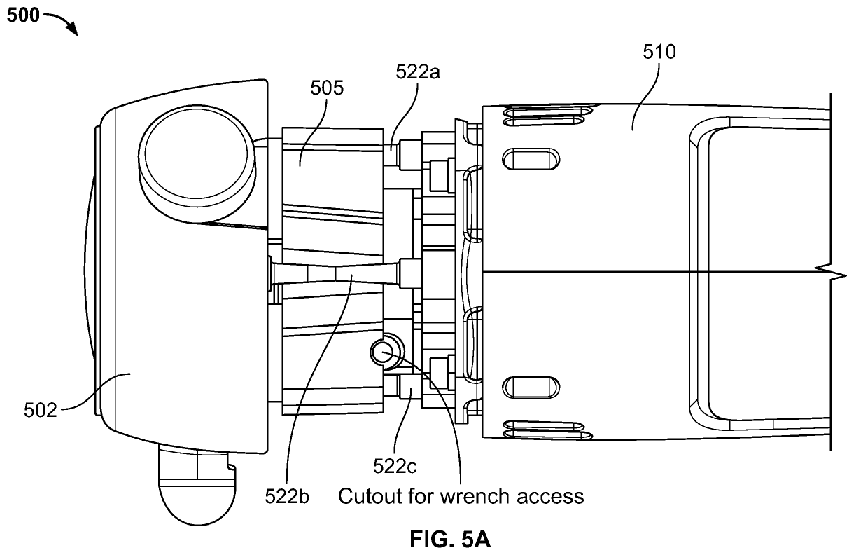

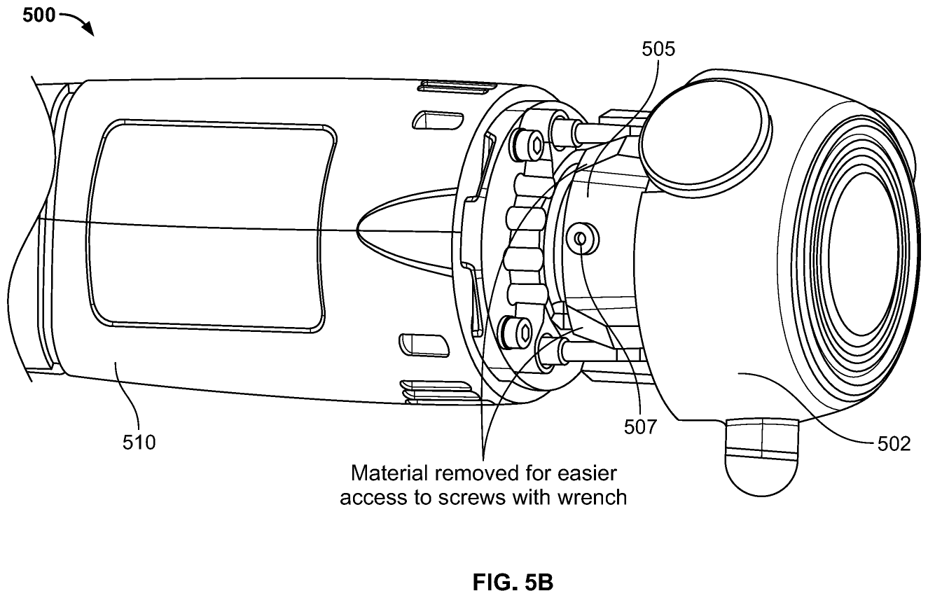

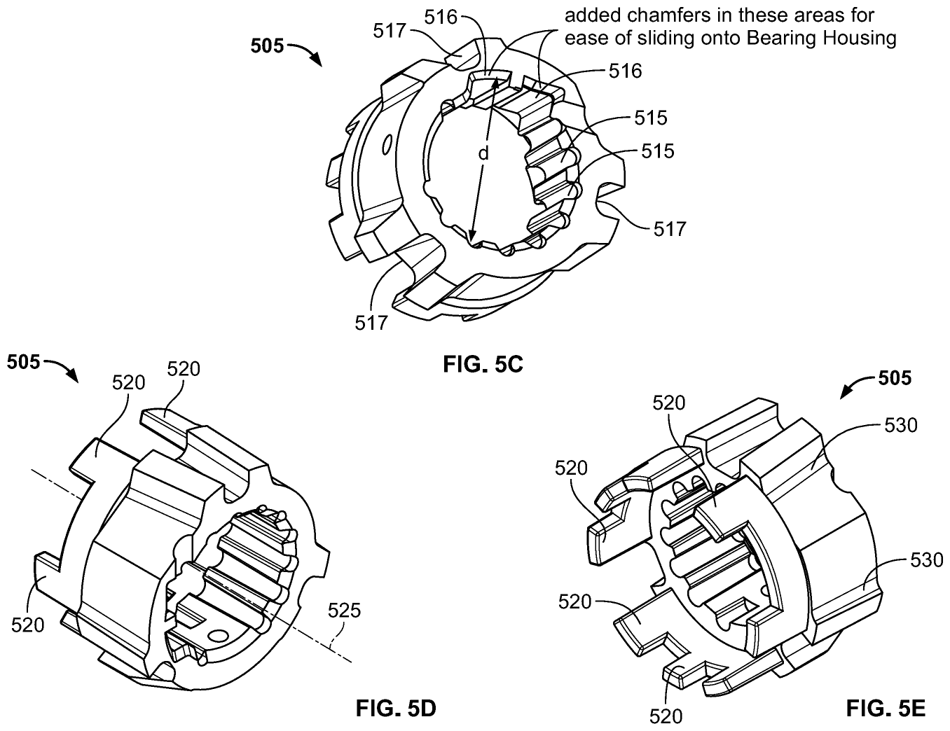

In various embodiments, various other restricting means that connect the head 400 to a body of the massager may be used. In an optional embodiment, the shafts of the pins (the portions between the distal and proximal ends) are positioned through grooves provided on a rotation stabilizer (also referred to as a crown, collar or cylindrical component), described in greater detail with reference to FIGS. 5A through 5E. Further, in an embodiment, a plurality of protrusions of the rotation stabilizer act as means to restrict a rotatory motion of the head while allowing for vibration of the head.

In an embodiment, the rotation stabilizer collar fits around the bearing mount assembly to at least restrict the circular motion of the vibrating head. In addition, the cylindrical component stabilizes the rotational aspect of the massager head such that the rotation is substantially circular and does not wobble or alter rotational movement should the stabilizing pins dislodge from their cylindrical sockets on the bearing mount assembly. Further, the placement of the cylindrical component or crown acts as a failsafe mechanism, ensuring stable substantially circular orbit should at least one of the pins bend, break, or otherwise detach from the assembly. Without such a stabilizer should the pins break, the massage head would rotate and subsequently affect the vibrational accuracy of the massage head.

The radial, arcuate surface on an outside of the vibrating portion (shown in FIG. 4C as 402) between each radial treatment area (404, 406, 408) is used as a treatment surface and may be covered with a compliant material or texturized differently. In alternate embodiments, more than three radial treatment surfaces are provided and positioned around the outer periphery of the vibrating portion (shown in FIG. 4C as 402). FIGS. 4D, 4E, and 4F illustrate additional treatment surface areas positioned between existing treatment surfaces 404, 406, and 408, and shown in different views of the massager. FIG. 4D illustrates a fourth additional treatment surface 430 positioned on the head 400 of the massager, in accordance with some embodiments of the present specification. FIG. 4E illustrates a fifth additional treatment surface 432 positioned on the head 400 of the massager, in accordance with some embodiments of the present specification. FIG. 4F illustrates a sixth additional treatment surface 434 positioned on the head 400 of the massager, in accordance with some embodiments of the present specification. Each treatment surface 430, 432, and 434 may be applied at different angles to the body or tissue of the user so as to achieve a different massage impact at each angle. In an embodiment, treatment areas or surfaces 430, 432, and 434 shown respectively in FIGS. 4D, 4E, and 4F, are positioned equidistantly around the periphery at a proximal end of the head 400. In an embodiment, treatment areas 430, 432, and 434 are positioned at 120 degrees from one another. In an embodiment, treatment surface 430 is positioned between surfaces 406 and 408, treatment surface 432 is positioned between surfaces 408 and 404, and treatment surface 434 is positioned between surfaces 404 and 406.

In embodiments, each treatment surface or area is constructed differently to provide a different type of massage therapy. An increase in the surface area may result in an increase in the power imparted to the body during massage. In an embodiment, stand-alone treatment surface 434 has a rubber surface, which creates more tension in the tissue. In embodiments, surfaces 430 and 432 have plastic caps. In embodiments, surface 430 has a pattern of multiple parallel grooves extending along a portion of the circumference of the head 400, where each groove extends from treatment surface 406 to treatment surface 408. In embodiments, surface 432 has a pattern of multiple small-sized grooves extending in multiples rows and spaces positioned evenly along a portion of the circumference of the head 400, whereby each groove extends in a direction perpendicular to the circumference of head 400, between treatment surface 404 and treatment surface 408. In embodiments, surface 434 has a pattern of multiple parallel grooves extending along a portion of the circumference of the head 400, where each groove extends perpendicular to a circumference of head 400 extending from treatment surface 404 to treatment surface 406. In different embodiments, different types and combinations of patterns may be used for surfaces 430, 432, and 434. In embodiments, the pattern on one surface may be vertical and while the pattern on the other surface is horizontal. In embodiments, each pattern on surfaces 430 and 432 is molded into the plastic. The patterns of surfaces 430, 432, and 434 may range from parallel vibration patterns to perpendicular vibration patterns and in every angular increment by varying the angle therebetween. Each surface pattern 430, 432, and 434 provides a different vibration effect.

FIG. 4G illustrates a silhouette of a massager 450 with exemplary dimensions marked in millimeters (mm), in accordance with some embodiments of the present specification. A complete length of the massager 450 from a proximal end 454 on handle 452 to a distal end 462 where the treatment surfaces 460 are configured, extends to approximately 285.95 mm. The body 464 of the massager is tubular along its length, with variable diameters. At the farthest proximal end, the massager 450 has a diameter of approximately 62.42 mm, while at the farthest distal end, the massager 450, the diameter is approximately 53.49 mm. A maximum diameter near the distal end of the massager is approximately 89.76 mm. A middle portion has a diameter that varies along the length of the handle between 54.28 mm and 57.86 mm.

FIG. 4H illustrates different views of a small treatment surface area 406 (shown in context in FIG. 4D) that comprises a rounded application area. A first view 462 illustrates a top view of the smooth spherical surface while a second view 464 illustrates a side perspective view of the small treatment surface area 406. FIG. 4I illustrates a top isometric view 466 and a bottom isometric view 468 of the large treatment area 404 (shown in context in FIG. 4F).

FIG. 4J is an illustration showing a top perspective view of a treatment cap 470. FIG. 4K is an illustration showing a bottom perspective view of the treatment cap 470. Treatment cap 470 is the external portion of a treatment area that provides a foundation for protruding arms, such as arms 476, to attach and install different types of treatment heads on the perimeter of the cap 470. A central circular surface 472 of the treatment cap 470, in embodiments, allows for a circular motion, which in addition to the vigorous vibration applied by the perimeter of the cap 470, provides for a gentle, soothing vibration parallel to the body. In embodiments, the large treatment cap 470 is molded onto the plastic substrate 474.

FIGS. 5A and 5B are first and second perspective views of the massager 500, in accordance with an embodiment of the present specification. The figures show a cylindrical component 505, also referred to as a crown, collar or cylindrical component, fitted over a bearing mount assembly placed between a vibrating head 502 and a body 510 of the massager 500 (as shown in FIG. 3). In accordance with an aspect of the present specification, the cylindrical component 505 serves a plurality of benefits, such as to block a gap between the vibrating head 502 and the body 510 of the massager 500 so that a recipient, patient or end user's skin, jewelry, or hair do not get caught or entangled and to act as one of the means of stabilizing, restricting or blocking rotation of the head 502 while allowing the head 502 to vibrate. In one embodiment, the cylindrical component 505 is securely attached to the underlying bearing mount assembly using one or more screws 507 (FIG. 5B).

FIGS. 5C, 5D and 5E are first, second and third perspective views of the cylindrical component 505 in accordance with various embodiments. In an embodiment, cylindrical component has a diameter ranging from approximately 1.0 inches to 2.5 inches. In an embodiment, the thickness of cylindrical component 505 ranges from 0.3 inches to 0.7 inches. Referring now to FIGS. 5A through 5E, an internal circumference of the cylindrical component 505, is adapted (in terms of the internal diameter ‘d’, for example) to fit around the bearing mount assembly. The internal circumference has a plurality of channels 515, or grooves, to allow for air flow and heat to pass through when the component 505 is fitted around the bearing mount assembly. In an embodiment, 11 grooves 515 are provided and are equidistantly spaced. In addition, a space is provided for grooves 516, which are used to receive the bearing mount assembly. An outer circumference of the cylindrical component 505, includes three channels 517, or grooves, to accommodate the shaft portions of the three pins 522a, 522b, 522c (also shown as pins 422a, 422b and 422c of FIG. 4B) that connect the head 502 to the body 510. Grooves 517 are positioned approximately 120 degrees from one another.

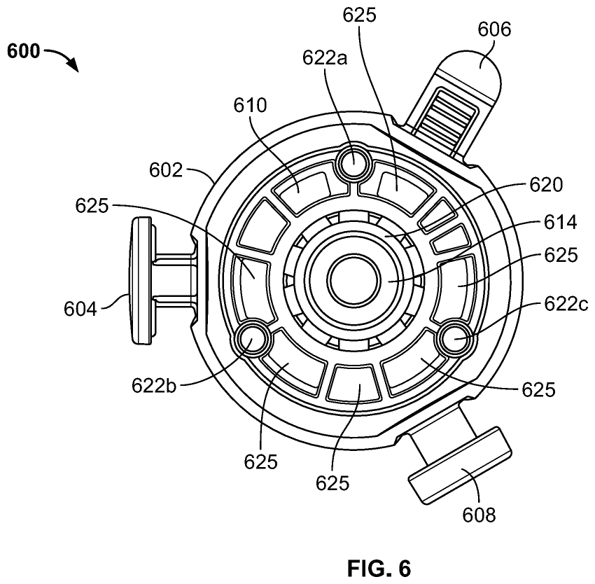

A plurality of protrusions 520, together forming a crown portion, extends from one side of the component 505 along a central longitudinal axis 525. The plurality of protrusions 520 are adapted or configured to conform and fit into a plurality of recesses (shown as recesses 625 of FIG. 6) formed into a base of the head 502. In accordance with an embodiment, the protrusions 520 have a non-friction fit into the recesses of the base of the head 502 to prevent the head 502 from rotating while allowing for the head 502 to vibrate. While the pins are spaced equidistantly from each other, the protrusions 520 are “keyed” or spaced to fit within the recesses such that there is only one accurate method of placing the components together. In some optional embodiments, the pins 522a, 522b and 522c may be eliminated, since the crown protrusions 520 act as means to restrict rotatory motion of the head 502.

FIG. 6 illustrates a back view of the vibrating head assembly of the massager, in accordance with an embodiment of the present specification. The ball bearing contact area 614 and at least one retaining member 620 are placed within the vibrating portion 602 as shown. Also an inside or rear surface of front cover 610 is visible through a plurality of recesses 625 formed within a base of the vibrating head assembly 600. The pins 622a, 622b and 622c connect the vibrating head assembly 600 to a bearing mount assembly and restrict free rotatory movement of the vibrating portion 602. Also visible in the figure are three treatment areas or surfaces 604, 606 and 608, in accordance with various embodiments.

In an optional embodiment, the vibrating head or portion 602 is covered with a cap having multiple surfaces. Each of the multiple surfaces acts as a treatment surface and may be used for massaging a body part. FIG. 7 illustrates a cap having multiple surfaces for covering the head of the massager. Cap 701 comprises a plurality of flat treatment surface areas 703a, 703b, 703c, 703d, 703e, and 703f. Each of these treatment surfaces may be applied to a user's skin for providing a massage therapy. In an embodiment, cap 701 is made of plastic. It would be apparent to persons of skill in the art, that any suitable material such as, but not limited to, hardened rubber, silicone may be used to construct the cap 701. Also, cap 701 may comprise multiple flat surfaces differently shaped and sized.

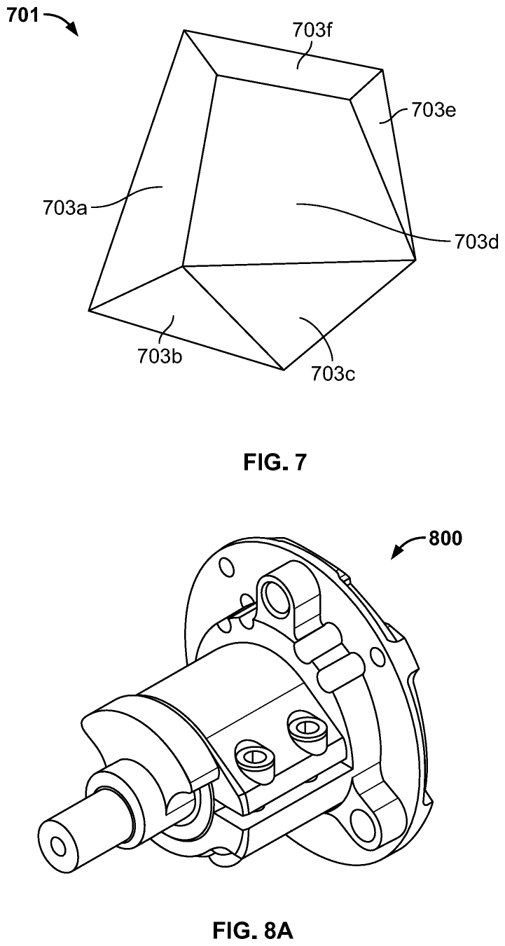

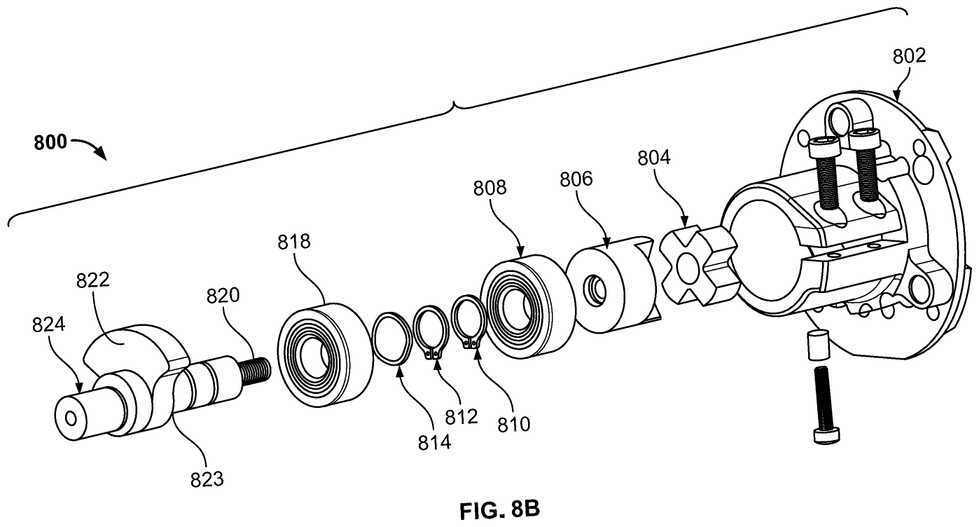

As shown in FIG. 3, bearing mount assembly is coupled to the motor of the massager via an eccentric shaft and the vibrating head via the rotational stabilizer and pin assembly. FIG. 8A is a diagram of the bearing mount assembly of the massager, in accordance with an embodiment of the present specification. FIG. 8B is an exploded view illustrating the bearing mount assembly of the massager, shown in FIG. 8A. Referring to FIGS. 8A and 8B, bearing mount assembly 800 comprises a bearing mount housing 802, which houses a spider shaft coupling 804, a jaw coupler 806, a first ball bearing 808, a second ball bearing 818, a first shaft 820, a counterweight 822, and a second shaft 824. In an embodiment, positioned within respective grooves of the two stacked ball bearings are a first retaining ring 810, a second retaining ring 812, and a wave spring 814. In an embodiment, first shaft 820 runs through the first ball bearing 808 and the second ball bearing 818, until a base of a cylindrical protrusion 823 housing the counterweight 822 rests above the second ball bearing 818. In an embodiment, the ball bearings 808 and 818 are separated by approximately 0.25 inches of first shaft 820. The portion of shaft 820 separating the two ball bearings provides greater stability to the massager mechanism during operation.

In an embodiment, counterweight 822 is positioned between first shaft 820 and second shaft 824. In an embodiment, second shaft 824 is an eccentric shaft. Eccentric shaft 824 is solidly fixed to a rotating axle at its proximal end, which in an embodiment is first shaft 820, with the central axis of the eccentric shaft 824 being offset from that of the axle of the main shaft 820. The degree of eccentricity or degree of offset of eccentric shaft 824 from the center axis of the main shaft 820 is, in one embodiment, ½ the stroke length. Counterweight 822 and second shaft 824 protrude from bearing mount housing 802 so that eccentric shaft 824 can be coupled to the massage head via a hole located within the massage head. In an embodiment a proximal portion of first shaft 820 exits the bearing housing so that it may be coupled to a shaft located on the motor assembly via the jaw coupler 806 and spider shaft coupling 804. Coupled in this manner, the eccentric shaft 824 allows for the rotational motion that is created by the motor and the main shaft 820 to be translated into an orbital motion.

In an alternate embodiment, a singular ball bearing may be used, wherein the single ball bearing is capable of retaining angular motion while minimizing pivot. In an embodiment, the singular ball bearing is an angular contact bearing.

In an embodiment, the counterweight 822 is shaped as a partial disc and comprises a top surface, a bottom surface identical to the top surface, a first side surface, a second elongated side surface and a third side surface identical to the first side surface. Counter weight 822 is coupled with a first cylindrical shaft 820 which in turn is coupled with a second cylindrical shaft 824. Shaft 820 is smaller in diameter than shaft 824. In conventional massagers, a counterweight is used to create motion such as for swinging the massage head from side to side. However, in various embodiments of the present specification, counterweight 822 positioned near the massager head balances the centrifugal forces created due to orbital movement of the vibrating portion of the massager head which is restrained by the use of three pins, as shown earlier. The centrifugal force would otherwise make the entire massage head shake during operation of the massager. The counterweight is sized and positioned to balance centrifugal force created by the constrained rotational forces.

In another embodiment, a second counterweight is also used in the massager for increasing stability. The second counterweight may be positioned in a different plane than the first counterweight closer to the massager's motor and further down from the head. The inclusion of more than one counterweight further minimizes a shaking of the handle of the massager during operation.

In various embodiments, the treatment surface provided on the center of the massage head of the massager also provides therapeutically beneficial heat without the use of a separate heater during operation of the massager. The bearing components surrounding the portion that receives the eccentric shaft in the massage head (shown as 614 in FIG. 6) and the bearing mount 802 coupled with the shaft generate heat because of friction during operation of the motor of the massager and is transferred from the center of the shaft through the plastic portions of the massage head. The heat is thus transferred through the shaft to a middle of the treatment surface provided on the center of the massage head. Hence, due to the positioning of the eccentric shaft relative to the treatment surface provided on the center of the massage head, heat is automatically generated and delivered through the center of that treatment surface. This allows for the delivery of therapeutically beneficial heat without the use of a separate heater.

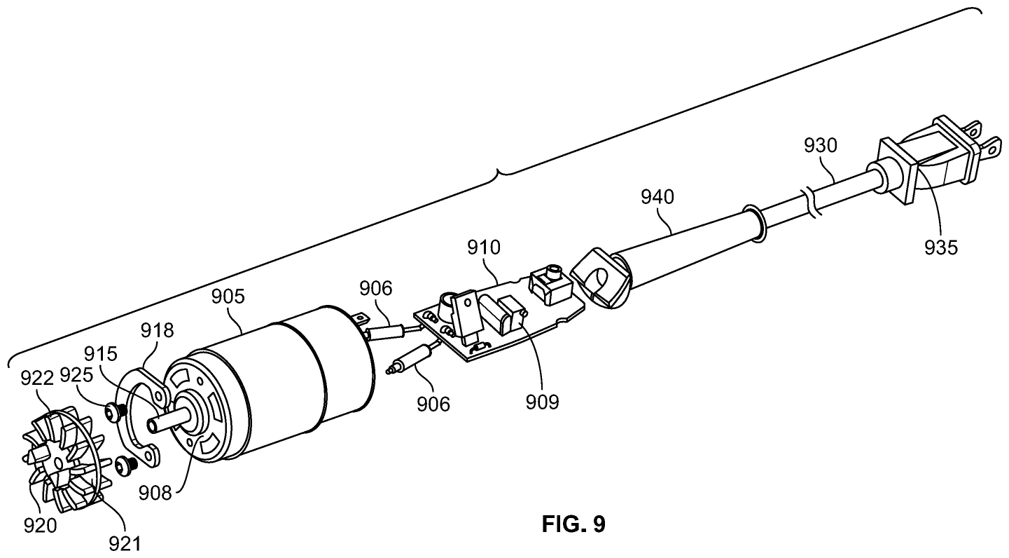

FIG. 9 is an exploded view illustrating the circuit board and motor assembly portion of the massager, in accordance with an embodiment of the present specification. In accordance with an embodiment, a motor 905 provides rotatory motion to a head of the massager. In various embodiments, the motor 905 may be a 110V or a 220V HVDC motor. A proximal end of the motor 905 is electrically connected (via connecting joints 906) to a printed circuit board assembly 910. An axle or shaft 915 protrudes distally from the motor 905 to support a coupling fan 920. The fan 920 is mounted on the axle or shaft 915 by placing the axle 915 through a central hole of the fan 920. The coupling fan 920 comprises a circular base 921 and multiple teeth 922 coupled with and protruding from a cylindrical shaft coupled with the circular base 921. A motor retention plate 918 is affixed to a distal surface 908 of the motor 905 by means of screws 925, to lie between the motor 905 and the fan 920.

The circuit board assembly 910 comprises a circuit board, a switch and a potentiometer 909. The switch is housed near the circuit board. The potentiometer 909 is positioned on the circuit board. The switch is coupled with the potentiometer 909 and the motor 905 and is used to control the rotational speed of the motor 905, which in turn controls the vibrational speed of the one or more treatment heads of the massager. In some embodiments, the speed of operation of the motor may be varied so that the frequency of vibration is modified. A power cord 930 extends proximally from the circuit board assembly 910 and ends into a power plug 935. In various embodiments, the power cord 930 is housed or sheathed in a strain relief housing or sheath 940 near a proximal end of the circuit board assembly 910.

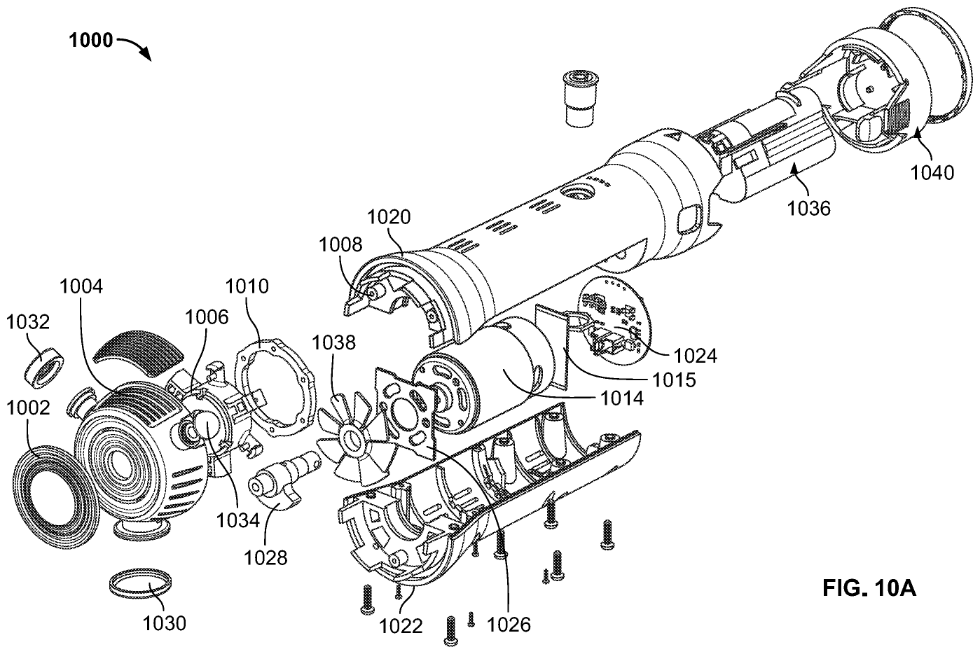

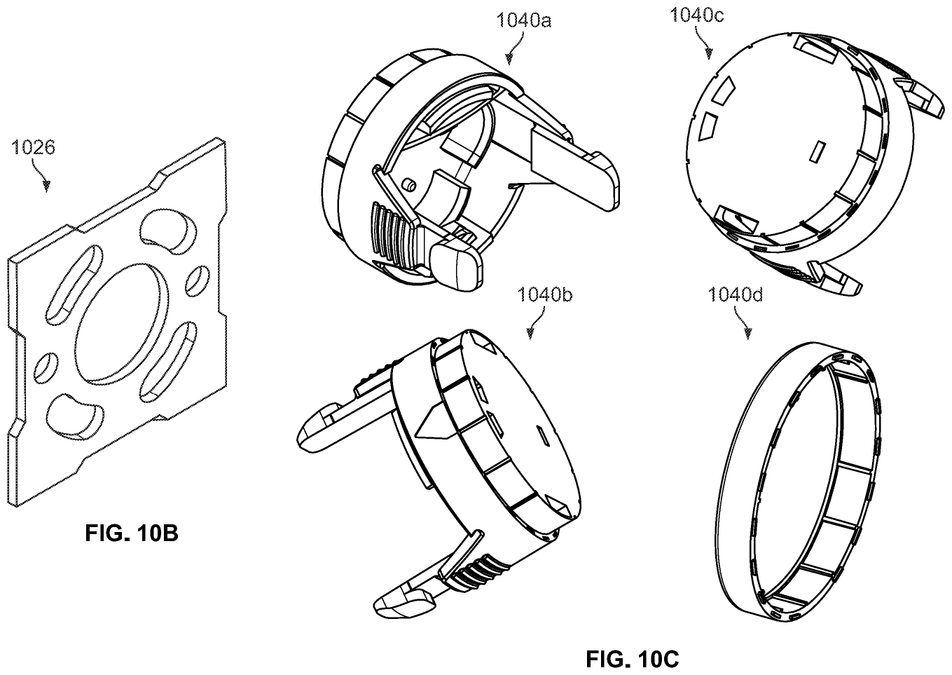

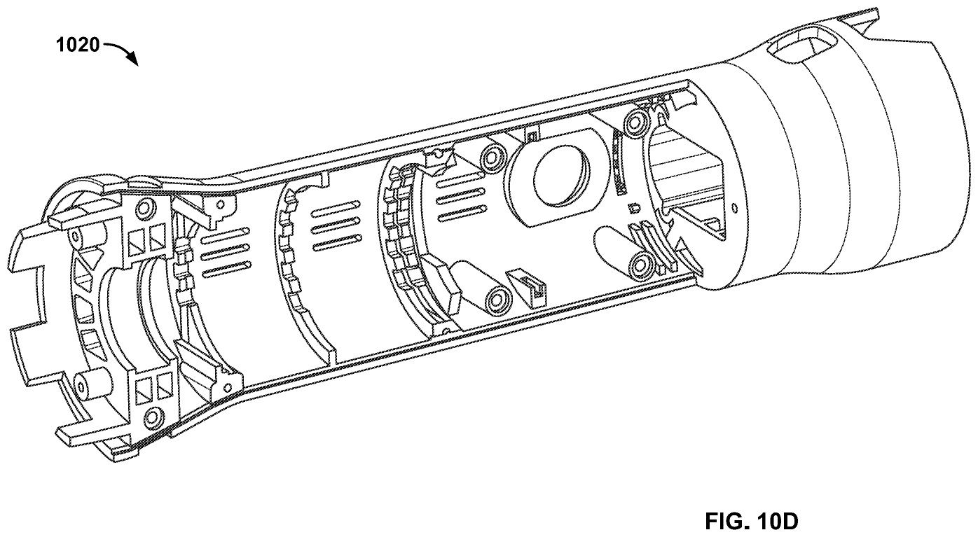

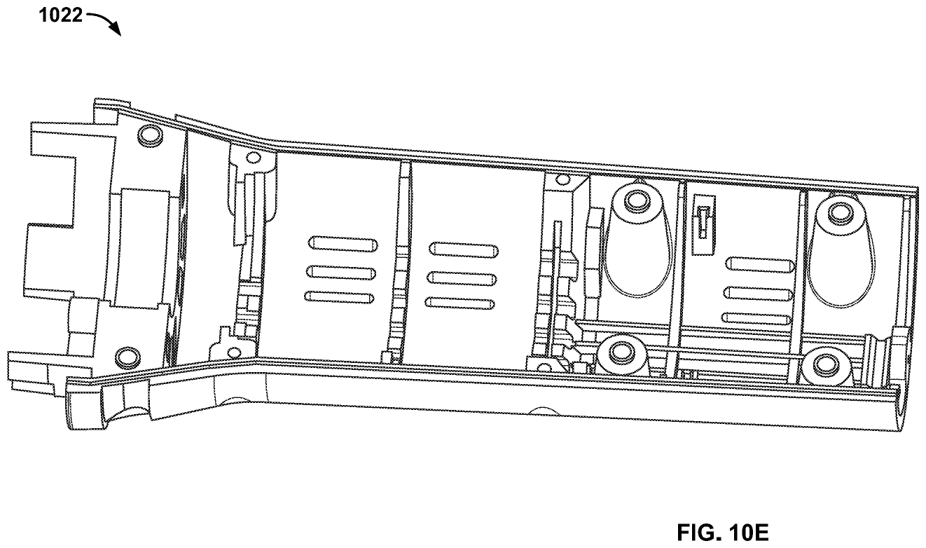

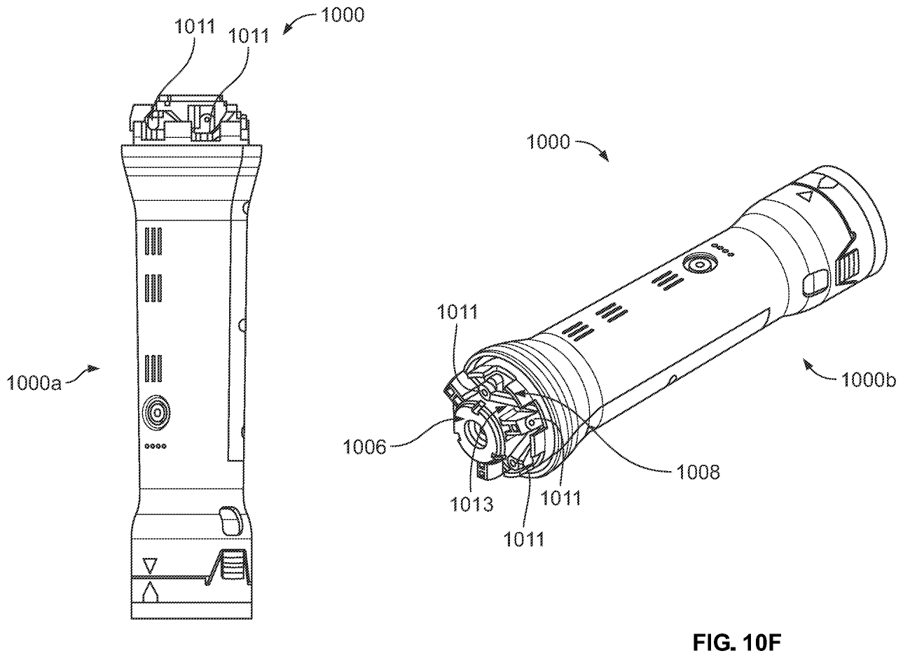

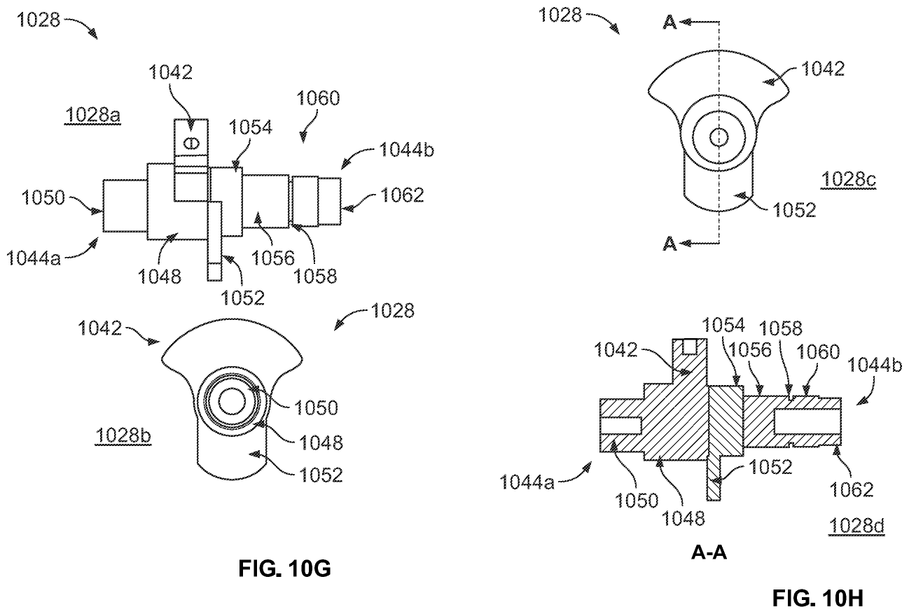

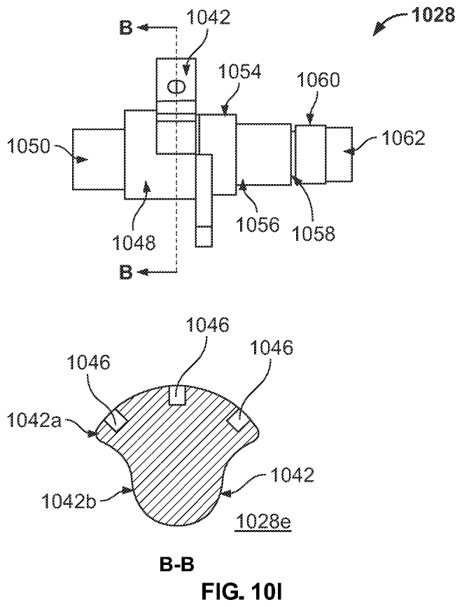

FIG. 10A is an exploded view of internal components of another embodiment of a massager 1000 using an alternative or additional restraining mechanism that is further described in context of FIGS. 10B to 12B, in accordance with some embodiments of the present specification. The additional restraining mechanism is positioned between a treatment head comprising, but not limited to, treatment area/disc 1002, orbiting head assembly 1004, and a bearing mount assembly 1008 that are incorporated into the internal surface of the handle portion. The view further illustrates other components of the massager, which have been stated and described previously in the specification. These components include, and are not limited to, a motor assembly 1014, first motor housing portion 1020, a second motor housing portion 1022, and a printed circuit board 1024. Massager 1000 may also include additional components such as screws and washers.

Orbiting head assembly 1004 (referred to as the vibrating head assembly 108 in FIG. 1A) is included in the head portion of massager 1000 and includes, a large planar treatment area 1030, a small rounded treatment area 1034, a soft planar treatment area 1032, and a front cover 1002. Front cover 1002 comprises a contoured treatment surface. Treatment areas or surfaces 1030, 1032 and 1034 are, in an embodiment, positioned equidistantly around the periphery at a proximal end of the head of massager 1000. In an embodiment, treatment areas 1030, 1032 and 1034 are positioned at 120 degrees from one another. Each treatment surface or area is constructed differently to provide a different vibrational effect for different types of massage therapy.

The treatment area/disc 1002 is detachably positioned within or connected via a pin or member to the orbiting head assembly 1004. Pins may connect the orbiting head assembly 1004 to a rubber ring 1010 through the rotation stabilizer or collar (also termed the sub-orbital head) 1006 which, in turn, is attached to the bearing mount assembly 1008.

The ring 1010 may include at least two equidistant holes positioned within its circumferential periphery. Where two holes are present, a first hole is used to position a screw to attach the ring to the orbiting head assembly 1004 through rotation stabilizer 1006. The second hole is used to position a screw that fixedly attaches ring 1010 to bearing mount assembly 1008. In one embodiment, and as illustrated in the figure, six equidistant holes are positioned within its periphery. In some embodiments, out of the six equidistant holes, three contiguous holes are used to position screws to attach the ring to the orbiting head assembly 1004 through rotation stabilizer 1006. The remaining three contiguous holes are used to position screws that fixedly attach ring 1010 to bearing mount assembly 1008. In some embodiments, out of the six equidistant holes, three alternate holes are used to position screws to attach the ring to the orbiting head assembly 1004 through rotation stabilizer 1006. The remaining three alternate holes are used to position screws that fixedly attach ring 1010 to bearing mount assembly 1008.

FIG. 10F illustrates both a top plan view 1000a and a perspective view 1000b of the massager 1000 that shows the connection of screws 1011 alternating between the head portion through stabilizer 1006 on one side and the handle portion through bearing assembly 1008 of massager 1000 on the opposite side. The alternating connection of screws 1011 creates a zig-zag pattern 1013 of connection, which prevents unwarranted spinning of components of massager 1000. Each segment of the zig-zag pattern 1013 oscillates between the head portion and the handle portion being attached, as it stretches, creates a force to make the head forcefully return to a center, while at the same time creating vertical pressure that holds the bearing mount assembly 1008 tight in the vertical axis, thereby mitigating noise. Referring again to FIG. 10A, the ring 1010 functions as an anti-rotation ring during use. Specifically, the configuration of alternating fixed connection points between the attach ring 1010 and the orbiting head assembly 1004 through rotation stabilizer 1006 and the attach ring 1010 and the bearing mount assembly 1008 allows for tension on the bearing mount assembly 1008, which decreases noise and extends battery life. Further, the “hard return to center” feeling would not be provided if the alternating connections points were not fixed in place. The bearing mount assembly 1008 and hence, ring 1010, rotation stabilizer/sub-orbital head 1006 and orbiting head assembly 1004 are mechanically connected to the motor assembly 1014. Motor assembly 1014 is positioned within a housing that is further positioned within the first motor housing portion 1020 and second motor housing portion 1022. FIG. 10D illustrates a view of an internal surface of the first motor housing portion 1020 in accordance with some embodiments of the present specification. FIG. 10E illustrates a view of an internal surface of the second motor housing portion 1022 in accordance with some embodiments of the present specification. The internal surfaces of the housing portions 1020 and 1022 are configured with protrusions and recesses of different shapes to fixedly house the motor assembly 1014, the battery compartment 1036, and all the other associated components, in their positions. In some embodiments, the handle includes a square-shaped cavity that receives and holds the bearing mount assembly 1008 and the motor assembly 1014. Proximal to the motor assembly 1014 and in electrical communication therewith is printed circuit board 1024 and a switch actuator. The figure also shows a counterweight shaft 1028 that is similar in purpose and description to counterweight 822 of FIG. 8B.

Referring to FIGS. 10G, 10H, and 10I, different views of the counterweight shaft 1028 are illustrated in accordance with embodiments of the present specification. FIG. 10G illustrates a side elevation view 1028a and a top plan view of a distal side 1028b of the counterweight shaft 1028. FIG. 10H illustrates a top plan view 1028c of a proximal side of the counterweight shaft 1028 and a cross-sectional view 1028d along a section A-A through a center of the counterweight shaft 1028. FIG. 10I illustrates a cross-sectional view 1028e along a section B-B, perpendicular to section A-A, of the counterweight shaft 1028. Referring simultaneously to FIGS. 10G, 10H, and 10I, counterweight shaft 1028 incorporates dual plane counterweights 1042 and 1052, that eliminate hand fatigue of the user by eliminating a vibration, motion, or a ‘wriggle’ at the proximal side of the handle where the battery is located. The counterweight shaft 1028 has two opposing sides—a distal side 1044a and a proximal side 1044b—which extend over a length of approximately 46.4 mm. Counterweight 1042 is positioned at a distal side 1044a of the counterweight shaft 1028, while counterweight 1052 is positioned at a proximal side 1044b of the counterweight shaft 1028.

FIG. 10I illustrates cross-sectional view 1028e of counterweight 1042, further showing its mushroom-shaped structure, with a first curved side 1042a and a second curved side 1042b. The first and second sides 1042a and 1042b are contiguously connected. The first curved side 1042a resembles a top of the mushroom, expanding with a curved edge that has a greater diameter than the curved edge of the second curved side 1042b. At least three square recessions 1046 are equally spaced at the curved edge of the first curved side 1042a. Each adjacent recession 1046 is positioned at an angle of 45 degrees measured from a central axis of counterweight shaft 1028. Each square recession 1046 has a width in a range of 2.5 mm to 3 mm. In one embodiment, each recession 1046 has a width of 2.7 mm. Counterweight 1042 has a thickness of approximately 6.5 mm, such that each square recession is configured at the center of the total thickness of counterweight 1042 with a height of approximately 2.7 mm.

Distal side of counterweight 1042 is attached to a cylindrical structure 1048 of a total thickness of 12.11 mm, of which approximately 5.61 mm thickness is positioned over the distal surface of counterweight 1042, and the remaining (approximately 6.5 mm) portion encompasses a partial circular edge of the second curved side 1042b of counterweight 1042. The distal circular portion of structure 1048 has a diameter of approximately 14.61 mm. Distal surface of structure 1048 is further attached to a hollow cylindrical structure 1050. Structure 1050 is concentric and coaxial with structure 1048 and has a length of approximately 8.50 mm. Structure 1050 has an outer diameter that is in a range of 9.968 to 10.028 mm and an inner diameter that is in a range of 4.970 to 5 mm. The hollow of cylindrical structure 1050 is configured to receive a shaft that connects counterweight shaft 1028 to the orbiting head assembly 1004 through rotation stabilizer 1006. Counterweight 1042, structure 1048, and structure 1050 together constitute the distal side 1044a of the counterweight shaft 1028.

A proximal surface of counterweight 1042 is attached to counterweight 1052.

Counterweight 1052 extends from a central axis of the counterweight shaft 1028 in a rectangular shape of width of approximately 13.34 mm, with a curved outer edge away from the central axis of the counterweight shaft 1028. The curved outer edge of counterweight 1052 is configured in a direction that is diametrically opposite to the first curved side 1042a. In embodiments, since counterweight 1052 stretches from the central axis of the counterweight shaft 1028, only a portion of the proximal surface of counterweight 1042 is attached to counterweight 1052. The remaining portion of proximal surface of counterweight 1042 is attached to a cylindrical structure 1054 that also encompasses an inner edge of counterweight 1052, and extends proximally in a circular cylindrical form to attach also to the proximal surface of counterweight 1052. Cylindrical structure 1054 has a length of approximately 6.92 mm and a radius of approximately 13.34 mm at its proximal side.

Further, the proximal surface of structure 1054 is connected to a series of contiguous cylindrical structures 1056, 1058, 1060, and 1062 that sequentially and coaxially extend from the proximal surface of the structure 1054 towards the proximal side of counterweight shaft 1028. Cylindrical structure 1056 is a partially hollow cylinder with an outer diameter in a range of 9.995 to 10.025 mm. The hollow portion extends within the cylinder for a part of its proximal length. The hollow portion extends throughout cylindrical structures 1058, 1060, and 1062. Cylindrical structure 1058 has a length of approximately 0.76 mm and an outer diameter of approximately 8.36 mm. Cylindrical structure 1060 has a length of approximately 4.88 mm and an outer diameter of approximately 9.7 mm. Cylindrical structure 1062 has a length of approximately 4.25 mm, and an outer diameter of approximately 8.8 mm.

A central axis of a first shaft positioned at an end on a proximal side 1044b of counterweight shaft 1028 (where the distal side 1044a of the shaft 1028 is positioned close to the orbiting head assembly 1004) is aligned with a fan 1038. A hole at the center of the fan 1038 provides a passage for positioning the proximal portion of counterweight shaft 1028. The proximal portion of counterweight shaft 1028 is further positioned within a central hole of a motor plate 1026 that covers the motor assembly 1014 on its distal side. FIG. 10B illustrates an isometric view of motor plate 1026, in accordance with some embodiments of the present specification.

A compartment 1036 for storing a battery to power the massager 1000 is configured within the handle portion. The compartment 1036 enables battery storage so that the battery is positioned to be in contact with the motor assembly 1014, printed circuit board 1024, and the switch actuator. A boost circuit, built on a boost board 1015 is positioned between motor assembly 1014 and printed circuit board 1024. The boost circuit may also be called a “Buck Boost” circuit and is designed to keep a steady voltage output to the motor regardless of the load. In embodiments, the battery is stored in the handle portion of the device towards a proximal side of massager 1000 enabling the massager 1000 to be positioned such that it stands and remains balanced in an upright or vertical position during and outside of operation. A battery cap 1040 is configured to be removably positioned at the proximal side of the compartment 1036. FIG. 10C illustrates different views of battery cap 1040 in accordance with some embodiments of the present specification. A first view 1040a represents a bottom isometric view of battery cap 1040. A second view 1040b represents a top isometric view from a first side of battery cap 1040. A third view 1040c represents a top isometric view from a second side of battery cap 1040, wherein the second side is diametrically opposite the first side. A fourth view 1040d represents an isometric view of a battery cap overmold that may be positioned on an outer periphery of the proximal side of the battery cap 1040.

In some embodiments, battery light indicators (not shown) are configured within the handle portion of the massager. At least one of or a combination of capacitors and microprocessors are used to integrate a boost board in communication with the battery and other electrical and electronic components of the massager 1000 that are supplied power by the battery. The boost board is a type of SMPS (Switch-Mode Power Supply) that combines a buck converter (to reduce voltage) and a boost converter in one combined circuit. The boost board is configured to keep the voltage steady, even if there is a reduction in battery power. The boost board enables operation of massager 1000 to run at its designated operating speed. The boost board comprises a boost converter, which in turn includes two components, a boost circuit and a switch. In embodiments, the boost circuit includes an inductor, a switch, a diode and a capacitor. A quick change in current through the inductor due to the switch results in a large voltage across it, which, in turn, creates a large current for charging the capacitor. The diode keeps the capacitor charged whereby the voltage keeps building up. In embodiments, the switch is a MOSFET. Additionally, a feedback mechanism is incorporated in the switch which stops the switching once the desired voltage has been attained. A battery board transfers power from the battery through the switch and out to the boost board. The battery board also controls LED indicator lights.

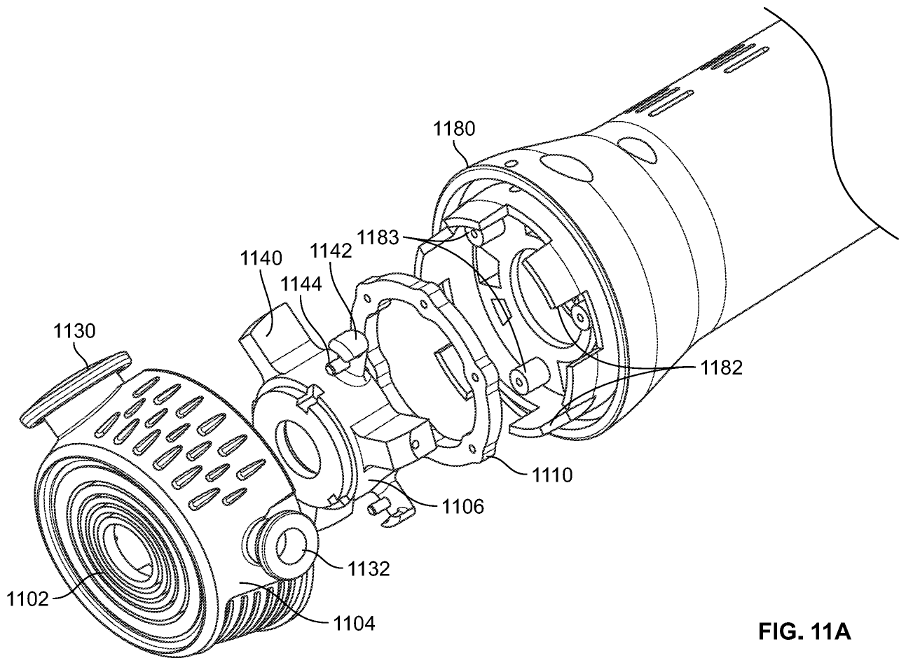

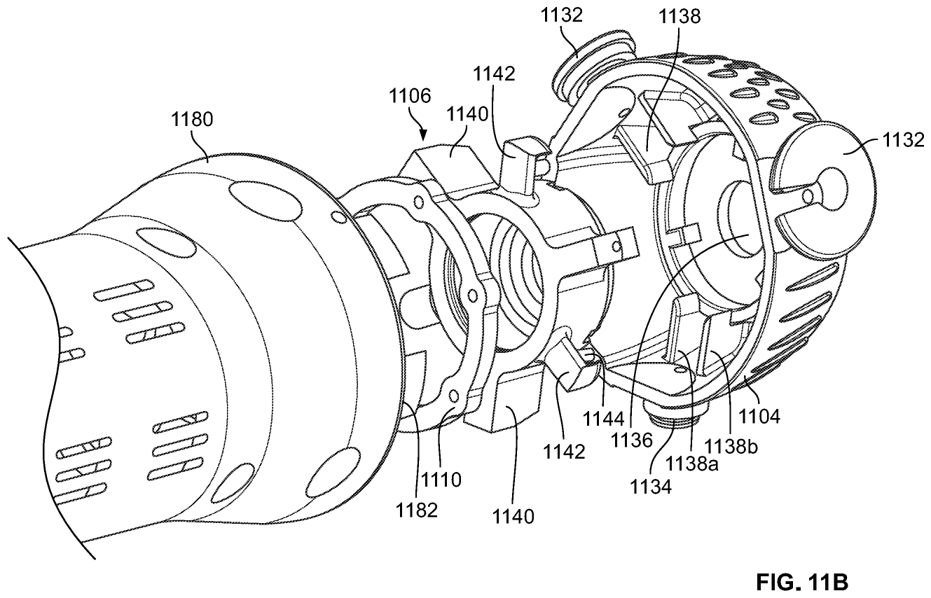

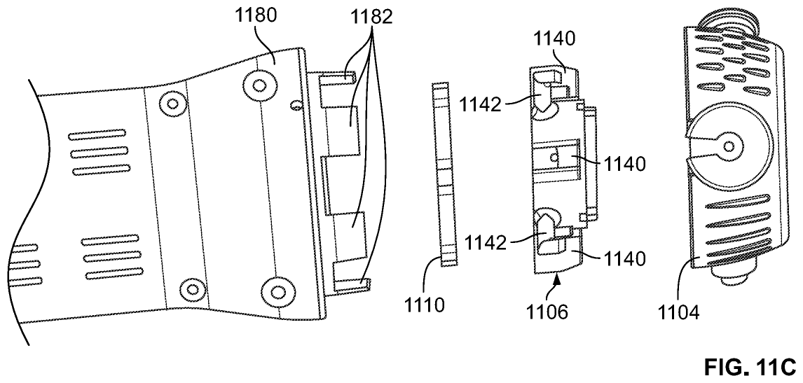

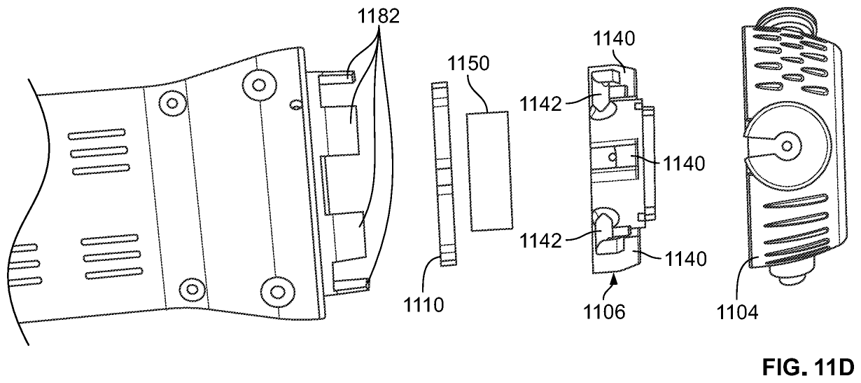

FIGS. 11A to 11C illustrate another embodiment of a restraining mechanism, in accordance with the present specification. Generally, an elastic ring structure 1110 is used to mechanically tether the handle and motor assembly with the orbiting assembly, which includes the sub-orbital and orbital heads, in a manner that a) allows the orbiting assembly to move in response to the motor rotating the orbital assembly while concurrently b) restraining the orbiting assembly to yield a vibratory effect. This is achieved by fixedly connecting the elastic ring 1110 to the handle and motor assembly at a first plurality of connection points and fixedly connecting the elastic ring 1110 to the sub-orbital head 1106 at a second plurality of connection points, where the second plurality of connection points are different from the first plurality of connection points, are adjacent to the first plurality of connection points, and/or are positioned in an alternating fashion with respect to the first plurality of connection points. The restraining mechanism of FIGS. 11A to 11C may be used instead of, or in addition to, the restraining mechanism of FIGS. 5A to 5E. Preferably, the aforementioned elastic ring based restraining mechanism is the sole structure restraining the rotational movement of the orbiting assembly.

More specifically, referring to FIGS. 11A-11C, the orbiting assembly comprises an orbiting head assembly 1104 and sub-orbital head 1106 that is attached to a motor and handle assembly 1180 via an elastic ring 1110. FIG. 11A illustrates an exploded top side perspective view of a restraining mechanism, in accordance with some embodiments of the present specification. FIG. 11B illustrates an exploded bottom side perspective view of the restraining mechanism of FIG. 11A, in accordance with some embodiments of the present specification. FIG. 11C illustrates an exploded side view of the restraining mechanism of FIGS. 11A and 11B. The orbiting head assembly 1104 is a substantially cup shaped structure having an internal cavity 1136. The internal cavity 1136 comprises a plurality of receiving sections 1138, wherein each of the plurality of receiving sections 1138 may be a clip comprising a first member 1138a separated from a second member 1138b by a space and wherein each of the first member 1138a and second member 1128b are attached to the internal surface of the orbiting head assembly 1104 and extend toward the center of the internal cavity 1136. There are preferably two or more clips 1138 positioned circumferentially around the internal surface of the internal cavity 1136. It should be appreciated that each of the plurality of receiving sections 1138 may be any structure configured to receive one or more members and may be of any shape, including cylindrical, spherical, curved, or polygonal. The orbiting head assembly 1104 further includes removable treatment surfaces including a large planar treatment area 1130, a small rounded treatment area 1134, a soft planar treatment area 1132, and a front cover 1102. The movement of the orbiting head assembly 1104 and the various treatment surfaces 1130, 1132, 1134 is similar to what is described in context of FIGS. 4A to 4C and is not repeated here for brevity. FIG. 11D illustrates a position of a bearing 1150 between sub-orbital head 1106 and elastic ring 1110. In embodiments, the restraining mechanism of FIGS. 11A to 11C is configured to position the restraining mechanism in the same place as a bearing 1150, so as to minimize wobbling or excessive load when the restraining mechanism is placed out of the same plane. The bearing 1150 is positioned within the sub-orbital head 1106 during assembly. In one embodiment, the bearing 1150 has a length of 10 mm, breadth of 30 mm, and a thickness of 9 mm. In some embodiments, the bearing 1150 is made using ceramic or a hybrid material that aid in noise reduction.

The sub-orbital assembly 1106 is preferably configured as a cylindrical member having a hollow internal cavity and a plurality of members extending outward from the external surface of the cylindrical member. The plurality of members preferably comprise a first set of members 1140 and a second set of members 1142 where each of the first set of members 1140 is configured to be slidably received into each of the plurality of receiving sections 1138 by a friction fit and where each of the second set of members 1142 is configured to receive a portion of the elastic ring 1110. Accordingly, the sub-orbital assembly 1106 is attached to the internal cavity of the orbital head assembly 1104 by fitting each of the first set of members 1140 extending outward from the sub-orbital head assembly 1106 surface into each of the plurality of receiving sections 1138, forming a first set of connection points, and is attached to the elastic ring 1110 using the second set of members 1142, forming a second set of connection points, such that a) the first set of connection points are different from the second set of connection points, b) the first set of connection points are adjacent to the second set of connection points, and/or c) the first set of connection points alternate in position with the second set of connection points around the circumferential periphery of the sub-orbital assembly 1106.

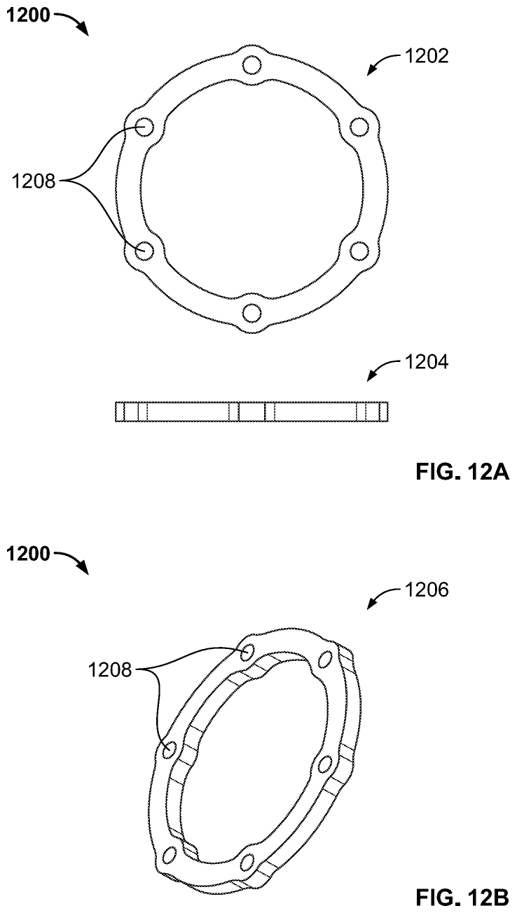

As further discussed below in relation to FIGS. 12A and 12B, the elastic ring is attached to the motor and handle assembly 1180 at a plurality of first connection points 1183 using screws, pins, clips, or any other fixed attachment means such that the elastic ring 1110, at each of the plurality of first connection points is substantially planar to the surface of the motor and handle assembly distal surface. The elastic ring 1110 is then pulled outward from the surface of the motor and handle assembly 1180 distal surface and extended over one of the second set of members 1142, which may be in the form of a hook, pin, linear protrusion, or other extended structure. The result, when alternated around the circumferential periphery of the elastic ring 1110, is a zig-zag pattern where a) the elastic ring 1110 is attached to the surface of the motor and handle assembly 1180 distal surface at a first point, b) the elastic ring 1110 is extended distally and over or around a first of the second set of members 1142 and then extended back down to the surface of the motor and handle assembly 1180 distal surface at a second point, forming a “V” or “U” shape (pointing distally) between the first and second points, c) the elastic ring 1110 is extended distally and over or around a second of the second set of members 1142 and then extended back down to the surface of the motor and handle assembly 1180 distal surface at a third point, forming a “V” or “U” shape (pointing distally) between the second and third points, and d) the elastic ring 1110 is extended distally and over or around a third of the second set of members 1142 and then extended back down to the surface of the motor and handle assembly 1180 distal surface at the first point, forming a “V” or “U” shape (pointing distally) between the third and first points. Accordingly, the elastic ring 1110 forms a non-planar connection structure attaching the motor and handle assembly 1180 to the sub-orbital component 1106, wherein a) the elastic ring 1110 is fixedly attached to the first set of connection points 1183 on the motor and handle assembly forming proximal connection points, b) the elastic ring 1110 is mechanically coupled to the second set of members 1142 of the sub-orbital component 1106 forming distal connection points, c) the proximal connections points and distal connection points alternate with each other around the circumferential periphery of the sub-orbital component 1106 and motor and handle assembly 1180 c) the elastic ring 1110 is not connected to the sub-orbital component 1106 or motor and handle assembly 1180 between the alternating proximal and distal connection points.

Preferably the distal surface of the motor and handle assembly 1180 comprises a plurality of protrusions 1182 forming cavities, valleys, voids, or spaces configured to physically receive, and restrict the movement of, one or more of the first 1140 or second 1142 set of members. Preferably the formed cavities, valleys, voids, or spaces are dimensioned to be wider than the width of the first 1140 or second 1142 set of members so that it allows the first 1140 or second 1142 set of members to move but not rotate in an unfettered manner.

FIG. 12A illustrates a top view 1202 and a side view 1204 of a rubber ring 1200, in accordance with some embodiments of the present specification. FIG. 12B illustrates a perspective view 1206 of the rubber ring 1200 of FIG. 12A, in accordance with some embodiments of the present specification. Referring simultaneously to FIGS. 12A and 12B, rubber ring 1200 is circular with a radius of approximately 25 millimeters (mm), a width of approximately 5 millimeters (mm) and depth of approximately 4 mm, except at places where the ring 1200 has a greater width of approximately 8 mm, so as to accommodate holes 1208. The holes may be circular with a diameter of 3.5 mm. In some embodiments, the holes are circular with a zig-zag formation around its circumference. As described above, holes 1208 extend and fit around extensions in a suborbital head. Holes 1208 are evenly spaced around the circumference of the ring 1200. Ring 1200 includes six evenly spaced holes 1208, where each hole extends through the depth of the ring 1200. A restraining mechanism is formed when the holes fit around extensions in the sub-orbital head. Three alternate holes are used to connect over the top of arms on the internal sub-orbital head and slip over the vertical rod to hold it into place. The other three alternate holes are secured to the bearing mount assembly using screws and washers. Once ring 1200 is fixedly attached to the head assembly on one side and the handle assembly on the other side, using alternating holes 1208 for each side, an orbiting head assembly is slipped over the sub-orbital head. Rubber ring 1200 is used to keep the head portion from spinning. Holes 1208 in rubber ring 1200, when secured, provide an effective solution to making the head portion return to center. On the other side, rubber ring 1200 fixedly attaches to a bearing assembly around a motor, and the bearing assembly is attached to the sub-orbital head. In embodiments, screws are used to fixedly attach the rubber ring 1200 to the bearing assembly. This restraining mechanism provides benefits such as keeping optimal containment pressure on the bearing and results in a quieter device.

The RRT massager of the present specification provides a precise combination of frequency and amplitude for causing fast, and effective pain relief. The RRT massager is safe, portable and easy to use, providing fast treatment options by targeting affected body areas, at a low operating cost. The dual-head portion and design of the RRT massager of the present specification, particularly the inclusion of a plurality of treatment surfaces, enables easy manufacturing of the massager. The RRT massager may also be used for assisting athletes in pre-workout power and post workout recovery. The RRT vibration therapy and massager of the present specification is effective in nearly every stage of treatment of multiple types of tissue ailments ranging from acute to chronic.

The above examples are merely illustrative of the many applications of the system of the present specification. Although only a few embodiments of the present specification have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A massager comprising:
a motor assembly comprising a motor positioned inside a housing, wherein the motor is configured to generate a rotational motion;
an applicator head comprising a plurality of treatment surfaces, wherein a portion of the applicator head is mechanically coupled to the motor;
a restraining mechanism mechanically coupled to said applicator head, wherein the restraining mechanism is configured to prevent the applicator head from rotating in response to the rotational motion, thereby generating vibrational motion in said applicator head, wherein the restraining mechanism comprises an elastic member attached to a surface of the motor assembly to form a first set of connection points and attached to a portion of the applicator head to form a second set of connection points and wherein the first set of connection points is positioned proximal along a longitudinal axis of the massager relative to the second set of connection points.

2. The massager of claim 1, wherein a position of each of the first set of connection points around a periphery of the elastic member alternates with a position of each of the second set of connection points around the periphery of the elastic member.

3. The massager of claim 1, wherein a position of a first of the first set of connection points around a periphery of the elastic member is proximal along the longitudinal axis relative to a position of a first of the second set of connection points around said periphery, wherein a position of a second of the first set of connection points around said periphery is proximal along the longitudinal axis relative to a position of a second of the second set of connection points around said periphery, and wherein a position of a third of the first set of connection points around said periphery is proximal along the longitudinal axis relative to a position of a third of the second set of connection points around said periphery.

4. The massager of claim 3, wherein the periphery of the elastic member has a circumferential shape and wherein each of the first set of connection points around the circumferential periphery of the elastic member alternates with a position of each of the second set of connection points around said circumferential periphery.

5. The massager of claim 1, wherein the applicator head further comprises a head comprising the plurality of treatment surfaces on an exterior surface of the head and a component configured to be received in a cavity of the first head.

6. The massager of claim 5, wherein the applicator head is mechanically coupled to the restraining mechanism by attaching the elastic member to the component.

7. The massager of claim 6, wherein the component is in the form of a ring having a plurality of members extending therefrom.

8. The massager of claim 7, wherein the elastic member is attached to the component at some of the plurality of members thereby forming the second set of connection points.

9. The massager of claim 7, wherein the component is mechanically coupled to the head by inserting some of the plurality of members into receiving structures within the cavity of the head.

10. The massager of claim 1, wherein the applicator head further comprises a head comprising the plurality of treatment surfaces on an exterior surface of the head and a cylindrical component configured to be received in a cavity of the first head, wherein the cylindrical components comprises a first set of radially protruding members and a second set of radially protruding members.

11. The massager of claim 10, wherein the elastic member is attached to each of the first set of radially protruding members to form the second set of connection points.

12. The massager of claim 10, wherein each of the second set of radially protruding members of the cylindrical component is mechanically coupled to receiving structures within the cavity of the head.

13. The massager of claim 1, wherein at least one of the plurality of treatment surfaces projects radially outwards from the applicator head.

14. The massager of claim 1, wherein the plurality of treatment surfaces includes a first treatment surface, a second treatment surface, and a third treatment surface and wherein the first treatment surface has a coefficient of friction that is different than the second treatment surface or third treatment surface.

15. The massager of claim 1, wherein the plurality of treatment surfaces includes a first treatment surface, a second treatment surface, and a third treatment surface and wherein the first treatment surface comprises a material that is more compliant than a material covering the second treatment surface or a material covering the third treatment surface.

16. The massager of claim 1, wherein at least one of the plurality of treatment surfaces comprises silicone.

17. The massager of claim 1, wherein a three of the plurality of treatment surfaces project radially outwards from the applicator head and are positioned equidistant from each other on a periphery of the applicator head.

18. The massager of claim 17 wherein an additional three of the plurality of treatment surfaces are positioned on the applicator head and between the three of the plurality of treatment surfaces that project radially outwards from the applicator head.

19. The massager of claim 1, wherein a frequency of the vibrational motion ranges from 75 Hz to 250 Hz and causes each of the plurality of treatment surfaces move in an approximately circular motion with a speed ranging from 100 to 200 circles per second.

20. The massager of claim 1, further comprising a rotating shaft mechanically coupled to the motor and an eccentric shaft mechanically coupled to the head for translating a rotational motion of the head into a substantially circular motion.

21. The massager of claim 1, wherein the housing is coupled with a counterweight for balancing centrifugal force caused by the substantially circular motion of the head.
